(19) United States
(12) Patent Application Publication
(10) Pub. No.: US 2019/0116480 A1
(43) Pub. Date: Apr. 18, 2019

(54) METHOD AND APPARATUS FOR A NETWORK AND DEVICE DISCOVERY

(71) Applicant: XPED HOLDINGS PTY LTD, Payneham (AU)

(72) Inventors: John Colin Schultz, Payneham (AU); Christopher Richard Wood, Payneham (AU); Philip David Carrig, Payneham (AU)

(21) Appl. No.: 16/090,116

(22) PCT Filed: Mar. 28, 2017
(86) PCT No.: PCT/AU2017/000074

§ 371 Date: Sep. 28, 2018

(30) Foreign Application Priority Data
Mar. 29, 2016 (AU) 2016901144

(51) Int. Cl. H04W 8/00; H04W 24/08; H04W 52/02; H04W 4/80; H04L 12/40

(52) U.S. Cl. CPC H04W 8/005; H04W 24/08; H04L 2012/40215; H04W 4/80; H04L 12/40; H04W 52/0229

(57) ABSTRACT

A low power control and monitoring network that is easy to setup operates using devices connected to a wired medium, each device having: unique identification, a CPU with a minimum power consumption state while powered by a power supply; a digital memory storing a resource management file of the device, a transceiver controllable by the CPU for communication on the wired medium wherein the transceiver is in an OFF state when the CPU is in the minimum power consumption state, a wakeup circuit generating a pulse of predetermined data or pulse characteristics for waking up the CPU and transceiver and for waking up the CPU of another device, the wake up resulting from the use of the communication of data including an address of the device on the network and to enable communication of a resource management file of at least one device to the other device.

### INCORPORATION BY REFERENCE

This patent application claims priority from Australian Provisional Patent Application No. 2016901144 titled “Method and apparatus for network and device discovery” filed 29 Mar. 2016. The entire content of this application is hereby incorporated by reference. Further, the description of the U.S. Pat. No. 9,136,913 owned by the applicant for this patent is incorporated by reference into this patent specification.

### FIELD

The field is control and monitoring networks and in particular where devices used in the network desirably operate so as to minimise network setup complexity and power consumption.

### BACKGROUND

Command and control networks exist in many areas of endeavour. A network of devices is made up of two or more devices that have a common understanding of what other devices are on the network or that will join the network, because they use the same operating system, have the same set of predetermined functionality, or have known device profiles, and each device is designed to use a known communications medium that permits connection of all the devices for the exchange of data. Thus, when devices are added to the network they can identify themselves and other devices in the network will know that device identity and thus know and expect a predetermined functionality from that device within the network.

Networks also have many configurations which permit devices to be powered, self-powered and when avail, to supplement the power available to support the network, and in most cases the source of power is the mains power system or a large battery array and converter designed to provide ample power for all devices and arrangement within the network. However, although power may be available for the existing devices and associated arrangements, it is not always possible to draw from that power source, thus requiring a supplementary power source dedicated to supplying power to an added device or devices, e.g. a temperature sensor and actuator arrangement newly installed into a cabinet housing a bank of server blades. In such circumstances where there is a need to minimise the power usage of added devices, the choice of central processing unit (microprocessor), the amount and type of memory, the type of network communication chip/s, the protocols used and their associated chips to effect communications and control, or when a device is merely a sensor (temperature, current, voltage, humidity, or any number of environmental and network characteristics) the current drawing characteristics, and when a device is used as an actuator for other devices, then the power consumed by this array of chips and sensors is an important factor in their choice.

This is particularly highlighted with the explosion of devices emerging with the Internet of Things (IoT) era, where there are predicated to be hundreds of millions of devices connected to the Internet, power consumption of the devices themselves and the networks connecting them is becoming increasingly important for resource conservation and general sustainability.

Additionally with the explosion of device types being developed to fulfil the needs of the IoT, it is practically impossible to design networks that can predict the wide range of device types that could be added to a network. Instead, the current state of the art allows networks to be built through the addition of devices that at already known to the network controller, by way of their functionally being already known through a device profile, device driver, or some other predetermined understanding of the device, or range of devices that can be added to the network. Thus it is possible to design a sensor network for example, that can communicate with a range of sensors; say temperature, humidity, etc. provided the controller of the network has a prior knowledge of how to control these devices. By way of further example, a home network may allow the addition of light switches, power distribution controller, power monitoring controllers, air-conditioning controllers, movement detectors, etc. However in these cases to add a new type of device, that may not be obvious to the initial intent of the network designer, may not be possible as that device may require a monitoring or control command interface that was not supported by the initial designer of the network.

For clarification, within the body of this invention the term sensor can refer to the traditional sensing element or circuits that read a state or condition of a parameter being sensed. However, devices can contain sensors (reading a state or value) and actuators (effecting a state, value, or element, such as controlling, switching or otherwise outputting a state change of a parameter) and are for the purpose of this document interchangeable without limiting the scope of the invention.

In this invention, the devices themselves contain a describing file (called a resource management file) that is transferred to the network controller or other devices that describes its monitoring and control commands, data structure, interface, security parameters, etc. thus the network controller or other devices within the network are able to interpret this file, learn and implement how to monitor and control this new device being added to the network. So whereas the existing state of the art may allow devices to transfer to the network files that contain parameters to configure a device, these parameters are a method of configuring a single device type or limited range of device types. Whereas in this invention the describing file can fully describe seemingly unrelated devices, from a simple dry contact, temperature sensor, power monitoring device, chemical sensors, automotive dashboard, electronic control panel, etc.

As such, this invention not only allows devices that exist today to be added to a network by describing themselves, but also accommodates devices that may be yet to be designed in the future to be added to an existing network, even though that network has no prior knowledge of these future devices, their functionality or control interface. This type of self-describing device is currently available through the Auto Discovery Remote Control (ADRC) technology and is described in more detail within the context of it point to point wireless applications in the ADRC patent U.S. Pat. No. 9,136,913.

The invention described within this current document further adapts this technology and re defines it's use in wired and hierarchical networks having the ability to contain a large number of devices, interconnected using possibly multiple transport layers with multiple connection types, while developing techniques that allow the minimisation of power consumption in large networks.

Furthermore, the discovery of devices newly added to networks can be a trivial function when the network is operating with normal power supply characteristics meaning that devices and their network communication mechanisms are normally ON. However, when devices are inherently or at times required to operate with low power drain due to limitations in the amount of power available, e.g. when many low power drawing devices form a network to monitor a computer network, it is not possible, or certainly less desirable, for discovery of new devices to use known techniques that require always ON communication hardware or for the device central processor and associated communication hardware to always be ON.

It is therefore beneficial that devices within the network can operate at a reduced power mode, yet be able to be woken up at the appropriate time in order to discover a new device, or communicate when necessary, data between devices. However it is often the case that the data communication mechanism in low power mode is OFF or in a non-data receiving SLEEP mode, such that data cannot be transmitted or received over this standard data communication mechanism. In some cases a listen only STANDBY mode may be supported, however in these cases the receiver generally still needs to be powered, so the current consumption can be higher than desirable for battery operated networks, particularly when a large number of devices are on the network. Thus it is beneficial in a network of devices to facilitate an out of band communication mechanism, separate to the standard data communication mechanism (referred to hereafter as simply the data communications mechanism) to effect the ability to signal devices to change to an ON state or at least a state such that allows further or standard communication using the data communication mechanism. It is advantageous that the power consumption of this out of band communication mechanism is of lower power than the data bus drivers or transceivers of the data communication mechanism to ensure an overall reduction of power of the system.

Networks are complicated and the physical interconnection of devices which make up the network is dependent wholly on the type or communication protocol to be used between devices, in certain networks, it is necessary to physically/electrically terminate not only the wired signal communication medium, e.g. CAN bus wire pair, but also designate the last physical CAN bus device as the terminating device, in any network each end of the wire pair. The process of creating these terminations is a manual process and subject to terminator positioning errors, or wiring error due to the non-symmetrical nature (such as having an IN and OUT designated connector) of the physical connectors and multiple connections at each device.

However, none of the known networks or devices, are configured to operate at a very low power consumption level while also: permitting detection of Nano-amps or pico-amps levels of signals until a device which wishes to report to the network, or is newly joining the network, or is involved in the reception and re-transmission of data within the network to change its state to effect one or more of the stated requirements; or which provides a mechanism for the network to determine, automatically, the address of the device and be discovered (physical presence, what that device is, and can do), or whether the device has become a terminating device in the network.
Additionally, due to the complexity of large networks, which can comprise of a large number of devices distributed over a physically large area, adds complexity to how devices are interacted with for configuration, setup, maintenance, general status updates, etc. Compounded with the desire to reduce costs of connected devices, many may not be manufactured with displays or interfaces. As such, the state of the art requires devices be monitored or configured from a central control panel or remotely through a terminal connected to a server for example. If the location of the central control panel or server terminal is remote to a device, carrying out tasks such as configuration, maintenance and monitoring can be limiting, difficult or impossible. A portable terminal can be carried by service persons required to carry out these functions. However in a large network of devices, trying to match a physical device to that on a long list of devices on a display screen can add uncertainty of a match.
In an aspect a method is developed to allow a device to be immediately and unambiguously identified and its control interface presented on a mobile device, allowing monitoring or configuration of a device using a close proximity or near field proximity mechanism where a mobile device or dongle is tapped or brought close to an active tap point or transmission point which is part of the device or remotely connected to the device. Once tapped, the control screen of the device is presented to the display of the mobile device, allowing a user to interact directly and locally with that device.

### BRIEF DESCRIPTION OF ASPECTS OF THE DISCLOSURE

Thus it is an aspect of the disclosure to provide devices that work within a network which permits any device to join the network and have another device within the network, discover the device, determine its functionality and then permit the device to be monitored or controlled using the network of devices.

In an aspect there is a sensor and control network using a wire signal communication medium connectable, and in use, connected to two or more devices to facilitate the communication of signals or pulses between devices in the network using a wire signal communication medium, comprising:
two or more devices, each device having:
   a power supply circuit energized and operable when connected to a source of electrical power;
   a central processing unit which has a minimum power state when powered by the power supply,
   a digital memory from which is readable including at least a resource management file, a unique identification of the device and one or more of:
      a digital representation of the type of device;
      a digital representation of the resource management file stored external of the device;
   at least one associated protocol transceiver controllable by the central processing unit,
   a communication driver for communication of the protocol from a protocol transceiver to and from the wire signal communication medium,
wherein the associated protocol transceiver and communication driver have an ON state and an OFF state and are in an OFF state when the central processing unit is in a minimum power consumption state,
   a wakeup circuit for waking up the central processing unit from an OFF state to change the state of at least the associated communication driver to ON, and
   a circuit to generate a predetermined pulse or data characteristic adapted to waking up a central processor of another device, wherein the circuit generates the predetermined pulses or data characteristic when instructed by the central processing unit;
      wherein the wire signal communication medium connectable, and in use, connected to each device of the two or more devices facilitates the communication of signals between devices using at least the communication driver of a respective device including the communication of data to enable use of a resource management file of at least one device to the other device.

In an aspect at least one of the devices further comprises a sensor associated with the device in communication with one or more elements of the device.

In an aspect the central processing unit of a device, once woken up, signals at least the communication driver of the same device to receive the unique identification of another device connected to the wire signal communication medium.

In a further aspect, the receipt of a unique identification of another device by the communication driver of a device prompts the device receiving the unique identification to assign a network address to the another device and communicate that network address to the another device.

In an aspect each device includes a sensor is able to be monitored and/or controllable as determined by the execution of a resource description file by a device that is connectable to the network of devices to control one or more devices.

In an aspect of the network the wire signal communication medium carries one or more power sources to one or more connected devices.

In an aspect of the network, a device including a communication mechanism and an out of band communication mechanism is able to receive a wakeup signal or command using the out of band communication mechanism, wakeup the device and communicate using the communication mechanism.

In another aspect there is a circuit for waking up a device from a minimum power consumption state, the device having a central processing unit which has a minimum power state and at least an associated protocol transceiver and communication driver connectable connected, in use, to a wire signal communication medium and for communication of the protocol to and from the wire signal communication medium, wherein the associated protocol transceiver and communication driver have an ON and OFF or minimum power consumption state and are in the OFF or minimum power consumption state when the central processing unit is in a minimum power consumption state, the circuit comprising:

a pulse detector having two signal inputs connectable and connected to the wire signal communication medium, and one output connectable and connected to the central processing unit of the device, the pulse detector having a pulse detection circuit for receiving a predetermined pulse or data characteristic, wherein when at least one pulse having a predetermined pulse or data characteristic is received by at least one of the signal inputs, a signal is generated on the output to wake up the connected central processor of the device, which turns ON the communication driver to receive signals on the signal communication medium.

In an aspect there is a reset circuit for resetting the waking-up device to a state to receive a further pulse absent the effects of a prior pulse.

In a broad aspect there is a pulse generator device controllable by a digital processor and the pulse generator device connectable and in use connected to a wire signal communication medium, the pulse generator comprising:

a pulse circuit for creating a voltage transition of either a positive or negative polarity about zero volts, or a predetermined level, at a predetermined rate where one or more pulse are generated and each voltage transition having a predetermined rise characteristic, and an interface circuit for applying the voltage transitions of the pulse circuit to a wire signal communications medium, wherein the voltage pluses generated are adapted to be received by a pulse detector.

In another aspect of the invention a device connected to a network using a wired communication medium is equipped with or connected to a circuit equipped with a near field or close field communication mechanism such that a mobile device also equipped with a near field or close field communication mechanism is brought within communication distance such that the respective near field or close field communication mechanisms such that data is transferred between the device and mobile device enabling data associated with the device to be displayed on the display of the mobile device.

In a broad aspect there is an arrangement for managing communication between two or more devices, the arrangement including;

a first device having a processor, memory, one or more communication mechanisms, the first device having access to one or more resource description files wherein one of those resource description files includes data representative of at least a portion of the resources for enabling communication with a second device; and

a second device having a processor, memory, one or more communication mechanisms, and the second device having no access to the one or more resource description files of the first device, where the first and second devices are connected such that at least one of the communications mechanism exchanges data with the other to facilitate the communication of a resource description file of the second device to the memory of the first device using one or more of the communication mechanisms for processing the resource description file by the processor of the first device to allow data to be exchanged between the first and second devices.

Some embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Some embodiments described herein may generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances or laptop computers. Thus, memory, processing and network resources may all be used in connection with the establishment, use or performance of any embodiment described herein (including with the performance of any method or with the implementation of any system).

Furthermore, some embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs), and magnetic memory. Computers, terminals, network enabled devices (e.g. mobile devices such as cell phones) are all examples of machines and devices that utilize processors, memory, and instructions stored on computer-readable mediums.

It should be appreciated that the present disclosure can be implemented in numerous ways, including as a process, an apparatus, a system, or a computer readable medium such as a computer readable storage medium or a computer network wherein program instructions are sent over wireless, optical, or electronic communication links. It should be noted that the order of the steps of disclosed processes may be altered within the scope of the disclosure.

“Software,” as used here in, includes but is not limited to 1 or more computer readable and/or executable instructions that cause a computer or other electronic device to perform functions, actions, and/or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

Those of skill in the art would understand that information and signals may be represented using any of a variety of technologies and techniques. For example, data, instructions, commands, information, signals, bits, symbols, and chips may be referenced throughout the above description and may be represented by voltages, currents, electromagnetic waves, magnetic fields or particles, optical fields, optical pulses, or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any background or prior art in this specification is not, and should not be taken as, an acknowledgment or any form of suggestion that such background or prior art forms part of the common general knowledge.

Suggestions and descriptions of other embodiments may be included within the disclosure but they may not be illustrated in the accompanying figures or alternatively features of the disclosure may be shown in the figures but not described in the specification.

It should be appreciated that the present disclosure can be implemented in numerous ways, including as a process, an apparatus, a system, or a computer readable medium such as a computer readable storage medium or a computer network wherein program instructions are sent over wireless, optical, or electronic communication links. It should be noted that the order of the steps of disclosed processes may be altered within the scope of the disclosure.

### BRIEF DESCRIPTION OF THE FIGURES

FIG. 1 depicts a network diagram showing the connections between devices of the network.

FIG. 2 depicts a functional block diagram of the hub of the network;

FIG. 3 depicts a functional block diagram of a node of the network;

FIG. 4 depicts a functional block diagram of a sub-node of the network;

FIG. 5 illustrates the data structures used in an embodiment for communicating between a hub and nodes;

FIG. 6A depicts a flowchart for determining end of line detection and auto termination;

FIG. 6B is a sequence diagram showing the steps involved in a node power up sequence including address allocation and end of line determination;

FIG. 7 depicts a functional block diagram of a wakeup detector circuit;

FIG. 8 illustrates an example of how a network of hubs, nodes and sub-nodes can be used to monitor the status of batteries in a battery backup application;

FIG. 9 illustrates a hub and nodes connected such that a node can detect if it is at the end of line in a network of devices;

FIG. 10 illustrates a hub and node network that is equipped with an out of band wakeup communications channel;

FIG. 11 illustrates a symmetric end of line detector circuit;

FIG. 12 illustrates examples of connector pin assignments for a CAN bus system utilising an EOL detect signal;

FIG. 13 illustrates a network of nodes utilising CAN bus to communicate and the positioning of CAN Terminators with the network;

FIG. 14 illustrates a CAN bus node that has the ability to switch an built in terminator ON or OFF;

FIG. 15 illustrates various types of CAN bus termination and examples of how to switch these terminators ON or OFF;

FIG. 16 illustrates the functional blocks of a voltage drop order detect circuit;

FIG. 17 illustrates EOL pulse randomisation; and

FIG. 18 illustrates a method of isolating power to a CAN transceiver.

### DETAILED DESCRIPTION OF EMBODIMENTS

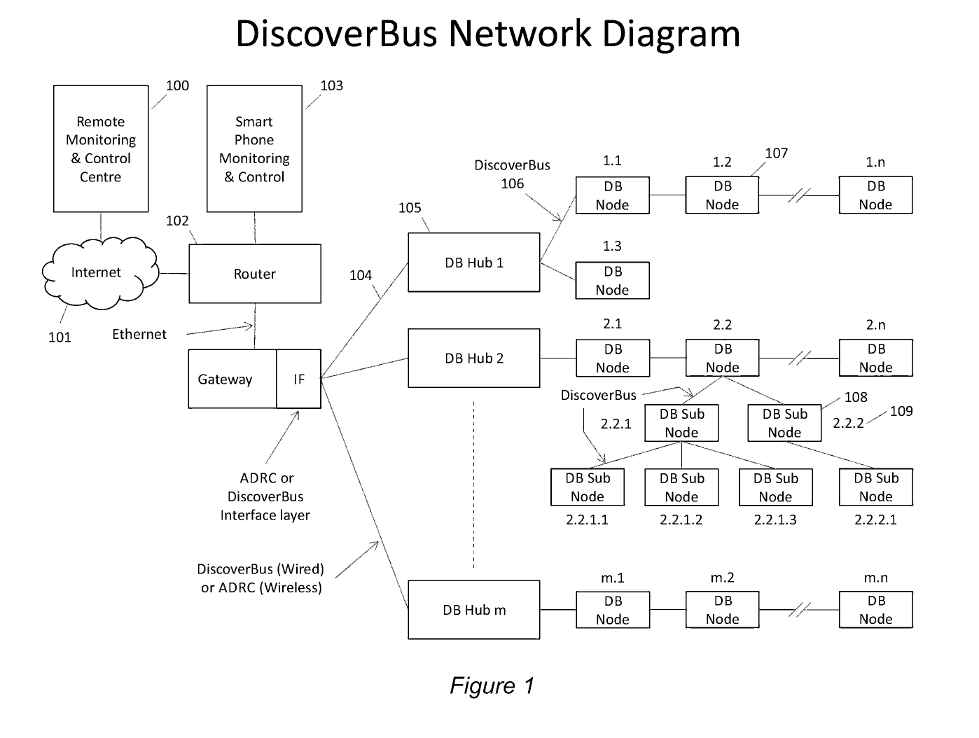

FIG. 1 represents an embodiment of network showing the connection of devices to form multiple hierarchical networks that permit any device to join one of those networks and have another device within the same network and in some cases other networks, discover the joining device, determine its functionality and then permit the joining device to be monitored or controlled using the network of nodes and devices (where the term device can represent a hub, node or sub-node), smartphone, tablet, or the remote server.

Although the definition of device is not meant to be limiting, for clarity purposes, a hub is generally a device that is the arbitrator or manager of a network of devices (sometimes referred to as nodes or sub-nodes) attached to a wire signal communication mechanism. A hub can issue addresses to devices that request an address, manages data communications on the network by maintaining the address of all connected devices, manages the addition and removal of devices to the network, etc. A hub can also manage communication external of the network and that may include communication between different networks. Although within this description, a hub is consistently illustrated as being at the beginning of a network of devices, it is not limited to this position in the network. It can also be positioned within other devices, or at the end of the network without limiting the definition of this patent. Additionally one or more devices may provide hub functionality within the network. In fact a node or sub-node may provide hub functionality, depending on the design requirements of the network and devices.

A wire signal communication medium can be a physical pair of wires; it could be a single wire; it could also be a bundle of wires; pairs of wires; or some other physical transport such as optical fibre, or the like. The wire signal communication mechanism comprises the physical wire or transport and an agreed signalling used on the wire/s to facilitate the exchange (transmission and reception) of signals/data/information with devices connected in some way to the physical wires, in which case the mechanism may include a controller of voltage, current, electromagnetic pulses such as light pulses in the case of optical fibre, etc.

A node is generally defined as a device that is added to the network through a wired connection/data bus to the hub and signals/communicates to the hub using this wired communication medium.

A sub-node is generally defined as a device that connects to a node or another sub-node, forming a hierarchical network. The wired medium that sub-nodes signal/communicate over can be separate to the hub/node wire signal communication mechanism and may in fact utilise different technologies and communication protocols chosen specifically to suit the needs of the device. For example, the hub/node wire signal communication mechanism could use CAN bus protocol, which can provide a high speed or long distance network backbone, with other parts of the network using the same or different wire signal mechanisms, chosen to suit the devices attached. The node/sub-node wire signal communication mechanism may use SMBus, I2C, RS485, LIN Bus, etc. to communicate signals/data over a local network. By way of further example, a local network of battery sensors may monitor a string of batteries in a data centre using sub-nodes connected with SMBus and the battery status data communicated back to a remote hub using the CAN protocol over the wire signal communication mechanism.

The term ‘DiscoverBus’ is used within this specification to refer to the one or more networks and their functionality as described herein, hence the use of the abbreviation DB within the figures and in the specification. This term is meant to be a title only and not limit, directly or indirectly, the interpretation of the devices and network/s described herein which are merely embodiments used to illustrate and teach the aspects disclosed.

A data communication mechanism can have several types of power modes and for the purpose of this definition and use within the body of this specification are described below.

OFF mode is considered to be a mode where the data communication mechanism is powered down such that it cannot either transmit or receive data. Generally this mode is activated if one or more of the power supplies is removed or one or more enable pins is disabled. It is the lowest power state and the functionality ranges from being severely limited to totally non-operable. Furthermore it cannot be woken up through internal or external processes such as interrupts, timers, etc. other than asserting one or more chip selects and/or applying the appropriate power supplies. Additionally it has the longest wakeup times transitioning from the OFF state to a state where normal data communications can occur.

SLEEP mode is considered to be a mode where the data communications mechanism is powered down such that it cannot either transmit or receive data. Generally this mode is activated if the required power supplies are provided, however one or more of the enable pins is disabled. It is a low power state and the functionality ranges from being severely limited to totally non-operable. Generally this mode supports self-wakeup or external wakeup through internal or external processes such as interrupts, timers, etc. as well as asserting one or more chip selects. It has faster wakeup times transitioning from the OFF state to a state where normal data communications can occur.

STANDBY mode is considered to be a mode where the data communications mechanism is limited to receive only. In this mode the receiver is turned ON allowing it to listen for data on the bus, or receive data on the bus. Generally this mode is activated if the required power supplies are provided, and the appropriate enable pins are enabled. It is generally a considerably higher power consumption state than OFF and SLEEP (often orders of magnitude higher). It has the fastest transition times to a state where normal data communications can occur.

ON mode is a fully operational mode where the data communications mechanism can operate in normal data communications mode. It is the highest power consumption mode and can be several times higher than STANDBY mode as the data transmitter is also enabled.

Thus, despite a range of power modes available, there remains a need in networks with limited power and/or a large number of devices, to minimise the power consumption, by allowing the data communication mechanism in devices to be in the OFF or SLEEP mode, yet allow for the ability to communicate data to and from devices when necessary, which may include when a device is joined or removed from the network, or otherwise needs to send or receive data, by providing an additional mechanism to allow the data communication mechanism to be woken up when needed to transition to a mode that allows data to be communicated as required. This mechanism can be referred to as an out of band communication mechanism, explained in more detail later in this document.

For the purpose of this document, and for simplicity, OFF and SLEEP modes will be considered interchangeable without effecting the intent of the meaning of the context or the overall invention. Similarly STANDBY and ON modes will be considered interchangeable without effecting the intent of the meaning of the context or the overall invention.

FIG. 1 shows in more detail, an embodiment, of how several DB hubs 1, 2, 3 . . . 105 can exist in a larger network of multiple DB hubs and many respective DB nodes. DB hub 1 is the hub for a local network attached to it having several DB nodes 107 each having a representative address 1.1, 1.2, . . . 1.n as well as a standalone DB node with a unique address within this network, namely 1.3. Thus, network 1 communicates externally of the network using DB hub 1 which is connected to the smartphone 103, or remote monitoring and control centre, in the manner described elsewhere and can be connected to networks associated with other DB hubs 2, 3, . . . n, and each of the other networks are formed using a wire signal communication mechanism. The topology of the networks is hierarchical and there can be numerous combinations of: series and star connections between DB nodes. DB Hub 2 is depicted as a local network of devices consisting of DB nodes 2.1, 2.2, . . . 2.n and also is depicted as comprising, an extension to the network, formed using Sub Nodes 307. Each DB node and DB sub-node has a network address to identify its position in the hierarchy of the network. For example DB sub-node 108 has an address of 2.2.2 (109), indicating that it is in the second DB Hub network (which has all of its addresses begin with an address element of 2), derived in this simple embodiment, since, the DB sub-nodes branch from Node 2 (with address 2.2) and is the 2^{nd} DB sub-node (address 2.2.2).

A network comprises a variety of devices. In the embodiments described, devices are used to monitor and control and are referred to herein as DB nodes, DB sub-nodes and interchangeably a DB device but there is at least one such node. A DB node may for example, comprise a temperature sensor, a remotely controllable switch, a light control circuit, a data logger of the operation of a computer, data router, a computer, a memory device, etc. and may be associated with other nodes, devices and networks such that a common feature of each device is the functionality of connecting to a wire signal communication medium. The minimum devices in a DB network are one DB node and a DB Hub (to be described). As will be described in detail the wire signal communication medium can be a simple pair of wires, or are of the type known as category 5 (cat 5), category 6 (cat 6) twisted pair or any suitable wire that can, for example, carry pulses (electromagnetic or electrical), signals, voltage (alternating and direct current), or in fact a optical fibre cable, etc. and not necessarily more than one of these requirements.

The network also comprises, in part, one or more DB nodes, and DB sub-nodes connected to the wire signal communication medium. More about the nodes will be described later in this document.

Each DB Hub1,2,3 . . . 105 is optionally adapted to connect wirelessly using, in a preferred embodiment, a wireless link 104, to a Gateway/Router 102 device, which may require an interface to the DB network, which can then communicate (when required) to a remote monitoring centre (server/remote monitoring and control centre) 100 over the Internet 101, using IP protocol for data communications over a wired or wireless link 104, that may for example, conform to the 802.15.4 or 802.11 standards, but that is a design choice. Optionally data link 104 may be a wired link, although the type of transport or protocol used is not limiting to the aspects disclosed. Additionally one or more Smartphones or tablet devices 103 can be used to control or monitor the network by communicating with Gateway/Router 102, typically using Wi-Fi.

The server is used to optionally maintain records of all the DB devices in respective networks 1, 2, 3 . . . and sub-networks, to issue commands to actuators and receive data from sensors associated with DB nodes in any of the networks and sub-networks. Information is also maintained in the gateway, hubs with nodes attached and nodes with sub-nodes attached.

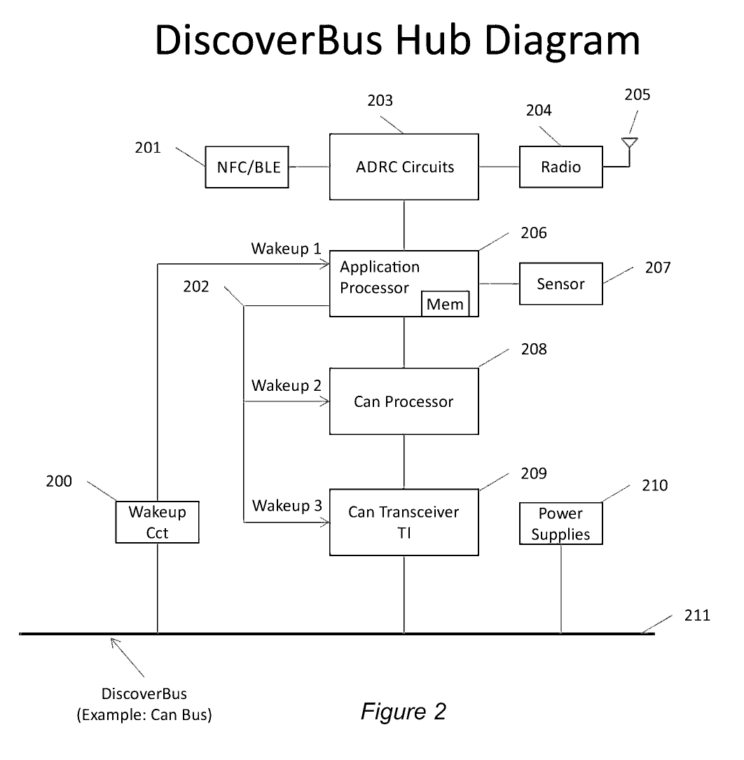

Each DB Hub device can be connected to multiple DB Nodes 107 using wires 106 of the type described, in serial configuration, as depicted in FIG. 1, only requiring the DB node to tap into the wires such that pulses, signals and current can flow between the DB node/s and the DB hub. It is also possible for the wires to branch as long as there is an electrically conductive path between the DB node and the DB Hub. Rather than the DB node being an interface between one DB node and the next, the connection is symmetric (can be used both ways and the node or hub will self-determine the use of each connector), as is better depicted in FIGS. 2, 3 and 4 and others.
FIG. 2 depicts a functional block diagram of an embodiment of a DB Hub device. For example, the DB Hub has an application processor and memory (Mem) 206 for receiving commands, controlling the data which is received and transmitted data received from a DB node or other source, as is described elsewhere in this document. The application processor also controls, at the appropriate time, a resource management file (RMF) which is initially stored in the source DB node, as a digital representation of the file, or a representation of the RMF which is stored elsewhere, for example, at a DB Hub or a remote server, received from a DB node. If a node or sub-node contains an RMF which is already known by the system/hub, then the RMF is not requested again. Thus if a network of 1000 battery sensors exists, then after the RMF for the first senor is fetched, the balance of the RMF's files (for 999 batteries nodes) are not needed, if the filename/hash/version-number of the RMF for the first node is the same each time a comparison is made to determine if the RMF identifier of the remote node or sub-node is known to the hub node or even at a remote control and command server. This approach saves time and energy since the size of an RMF (or the Resource Description File as it is referred to in the US patent incorporated by reference) which is, in an embodiment, written in XML format, may be so large, that if each time the node had to make that large file available to the Hub then it would take much longer than the proposed alternative, and considerable savings are achieved in bandwidth and power usage, which can be critical if the only source of power is a battery.

Noting that until the RMF is received, the DB Hub for that network, or DB hubs of other networks, will know nothing about the new node or sub-node device. The DB hub will (as will be explained in greater detail later in the specification), allocate an address for the new DB node on the respective network, and it is, with the provision of a respective RMF, that the DB Hub can then know what the new node is, does and how it does it. A resource management file is a digital representation of operational requirements of the DB node, sufficient for a DB hub to receive data from the DB device and communicate that data external of the DB network and the DB hub and further to provide commands in accordance with the resource description file of the relevant DB node to control the operation of the DB node.

The application processor and the Controller Area Network (CAN) processor, depicted in FIG. 2, may be a single processor/chip. Additionally the ADRC circuits 203 may also be incorporated into a single chip. The use of a CAN processor is only an embodiment, as other processors and associated protocols can be used in the one network. It is also possible for other networks, which are used to extend from any of the DB nodes or even the DB hub, to us other network processors and respective protocols, such as Serial UART, RS485, SMBus, I²C, BACnet, ModBus, LIN (local interconnect network) etc. bus communication technologies.

Thus, where the DB node is a temperature sensor the processor of the DB hub can control the collection and release of the temperature sensor readings over time, the processor may in some circumstances, process data from the different types of sensors (device types, wherein each device has a stored, readable, or available, digital representation—that representation being included in the RMF of each device) in the whole DB network, it may maintain details of the status of devices external of the DB network that are supplied by various of the associated DB nodes, such as a controller of a computer, a power management system and elements external of the DB network, etc. temperature readings, and other maintenance characteristics are also available from devices, computers and sensors associated with devices and systems. It will be up to the computer engineers and systems engineers as to how best to take advantage of the ready availability of temperature and other sorts of data, and it will also be a factor to consider how often the information is logged, so for long cycle characteristics the interval between measurement or checking can be longer than for short cycle characteristics, the frequency of readings and communication directly affecting the power consumption.

The DB Hub device is likely to have a processor devoted to communication to and from the wires 211 (FIG. 2) which are arranged as depicted. In this example, a DB bus processor/controller, is a CAN bus processor, and a corresponding protocol transceiver (transmitter/receiver) for communication using the relevant protocol onto and from the wires. In this embodiment, a CAN bus transceiver 209 adapts signal levels from the bus to levels the CAN controller expects and has protective circuitry that protects the CAN controller and converts the transmit-bit signal received from the CAN controller into a signal that is transmitted onto the wires (bus). Alternative, but not necessarily the only other, communication protocol examples include, Serial UART, RS485, SMBus, I²C, BACnet, ModBus, LIN (local interconnect network), fibre optic transceiver interface, etc. bus communication technologies and the like for which there are equivalent controllers and transceivers. In accordance with the preferable functionality of the arrangement the electronic chips that provide these protocol functions, the chips have a low power state which is switchable and controllable by in this embodiment by the application processor 206.

A sensor 207 could be any one of the types of sensors as used with a DB node, and thus could perform one or more of numerous sensing functions. In one example, the sensor is a temperature sensor for a computer processor blade array, or each cabinet in a room of cabinets, and in each cabinet there are one or more computer servers, or the temperature of a compressor arranged to provide cooling air to the room of server, etc. Of course, the sensor could be a door open/close sensor for the computer room, or each door of each cabinet in a room of cabinets in the computer room; it could be a light switch or sensor to detect the status and/or operation of a light switch, etc. Additionally the sensor in this case can represent an actuator, where an output is controlled, such as a relay, Pulse Width Modulated (PWM) output, analogue or digital output, etc. The type and function of the sensor is not relevant to the invention, just that the sensor input or output can be communicated by the DB hub to all other DB nodes (supporting sensors, devices, etc.) in the same network, and beyond as needed to a remote command and control server, or even to other networks via their respective DB Hub and the DB nodes part of those other networks.

The DB Hub connects to the wire signal communication medium 211 (FIG. 1 the Discover Bus 106) which connects to one or more DB nodes and as shown, and the DB hub connects to remote servers using any convenient communications including what has been described in the us patent included in this specification by reference, known as the ARDC technique, broadly illustrated by connecting lines 104, which is in this embodiment, a wireless arrangement, and as also depicted in FIG. 1 as a gateway 102 direct to the collection of computers which provide what is termed the Internet 101 (FIG. 1), which in effect is a communication medium between the DB hub and a relevant server at a remote control and monitoring centre 100 (FIG. 1).

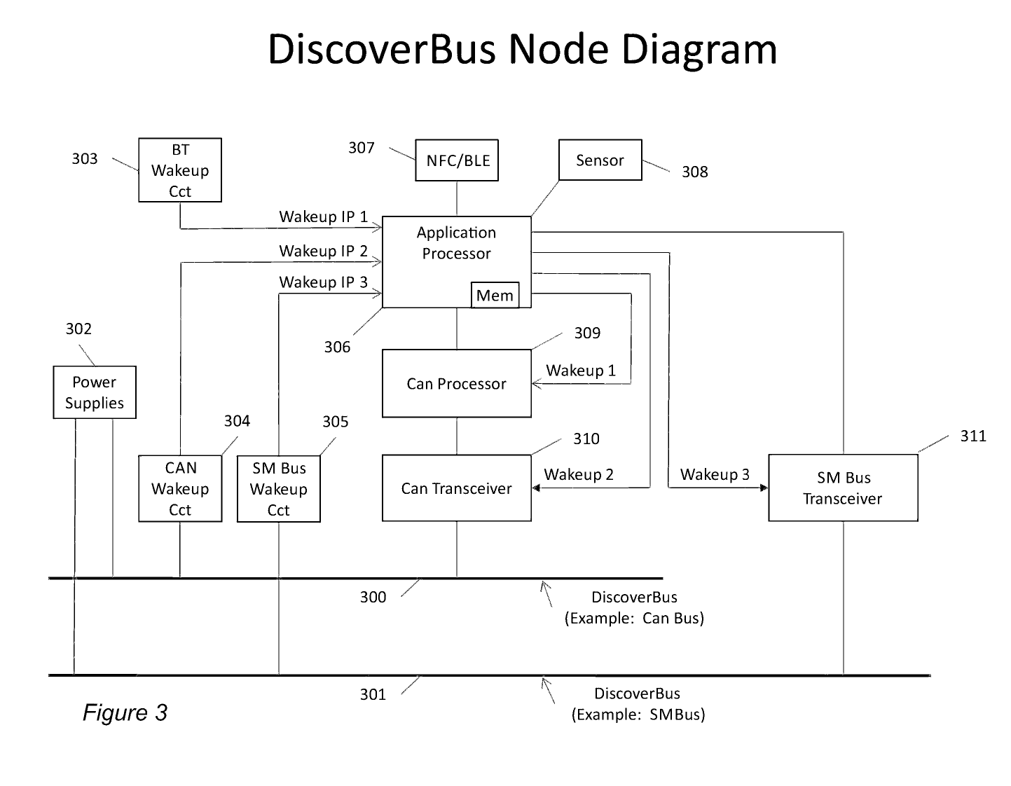

FIG. 3 depicts a functional block diagram of an embodiment of a DB Node device. For example, the DB Node has an application processor and memory (Mem) 306 for receiving commands, controlling the data which is received and transmitted data received from a DB hub or other source, as is described elsewhere in this document. The application processor also stores data representative of a resource management file (RMF) that includes a resource description file and which is stored in the device memory. In this example a node has the ability to transfer data from one transport mechanism; CAN bus 300 to a second transport mechanism; SMBus 301.

CAN data passes from the CAN bus to the application processor using CAN processor 309 and CAN transceiver 310. The CAN processor and application processor may be incorporated onto a single integrated circuit package. SMBus data passes from the SMBus transceiver to the application processor. The CAN processor and transceiver may be powered up from a low power or sleep mode into an operating mode from Wakeup signals 1 and 2. These wakeup signals are generated from the application processor in response to wakeup inputs WAKEUP IP 1, 2 or 3. These are generated from a CAN Wakeup circuit 304, SMBus Wakeup circuit 305 or BT Wakeup circuit 303. The CAN wakeup circuit is designed in such a way that it outputs signals and pulses in response to data signals and pulses on the CAN bus, such as the CAN+ and CAN− lines of this bus. Similarly the SMBus wakeup circuit outputs signals and pulses in response to data signals and pulses on the SMBus lines, such as the Clock, Data or Interrupt lines of this bus. The BT Wakeup Circuit can represent any out of band transport layer, however in this example it represents a Bluetooth radio transceiver, more specifically BLE, or BLE Mesh allowing this mechanism to wirelessly wake up nodes. This can be beneficial if the application processor already has Bluetooth circuits incorporated. Additional examples of out of band wakeup mechanisms are NFC (Near Field Communication) or other near field data transfer mechanisms, low power Wi-Fi, infrared, ultrasonic, audio, optical, magnetic, etc. The important aspect here is that to achieve an overall power saving, the power consumption of the out of band transport mechanism has a lower power consumption than the wire signal communication medium when in the ON state.

Power supplies 302 provide the necessary voltage and currents to supply the node circuits.

As described in detail for the Hub, Sensor 308 is connected to the application processor for the communication of sensor or actuator data.

The hub depicted in FIG. 2 is equipped with optional NFC/BLE circuits 201 typically used for pairing the device to the gateway/router 102 in the case where the hub/node connection 104 (as seen in FIG. 1) is wireless. Optionally similar NFC/BLE circuits can be added to the node. However the purpose of these circuits is not for pairing, but for allowing a suitably equipped mobile device such as a smartphone, to be tapped or brought into close proximity to a node to enable the control interface or other data associated with the node to be displayed on the mobile phone's display. During the tap process, an identifier of the node, an address or other unique identifier, is transferred to the phone over the BLE/NFC data link. This identifier is then used to retrieve the RMF, or other data as determined, from the RMF or data store, which might be in router/gateway 102 or remote centre 100 (as shown in FIG. 1).

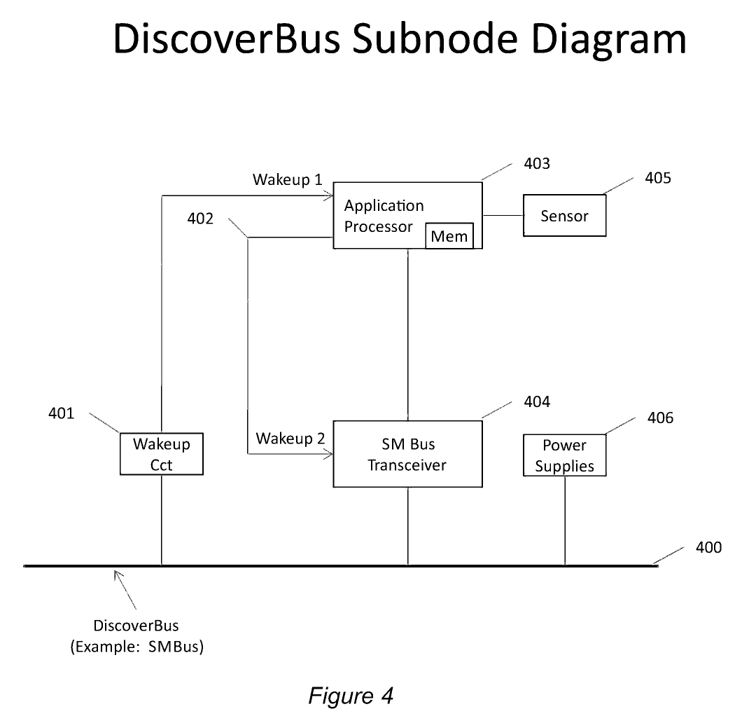

The sub-node depicted in FIG. 4 represents a much simplified device consisting of an application processor and memory 403, associated sensor 405, power supplies 406, interfacing with transport 400, being an SMBus transport layer in this example. SMBus consists of one clock and one data line. Optionally an interrupt line can also be used allowing a device (the sub-node in this case) to signal the SMBus master device (in this case a node). Thus, utilising the interrupt allows a sub-node to signal the wakeup of a node from a low power state, making the node transition to a higher power data communication state such that data can be communicated from the sub-node to the node. The microprocessor of the sub-node may wakeup on a regular schedule, or be woken up from a sensor interrupt on an event. This system is useful for reduced power implementations as the sub-node can operate asynchronously to the node, sending alerts or transferring data when necessary. An additional wakeup circuit 401 may be added in the case where the node may wish to wake up the sub-node to communicate data.

In one embodiment the proposed network as shown in FIG. 1 has three operational modes:

I. Address allocation mode

II. Data transfer mode

III. Removing disconnect nodes

I. Address Allocation Mode:

In this mode, DB nodes request address from a DB hub and the DB hub sends an allocated address to the new node.

Address allocation process steps are as described below:

1. Node power up.

2. Node activate, in this embodiment, a CAN filter to just receive a command from the DB hub (not from other DB nodes which may be in the network already—the filter is arranged to ignore all frames generated by other DB nodes, which is also potentially sending that type of frame as a result of being powered up—per step 1).

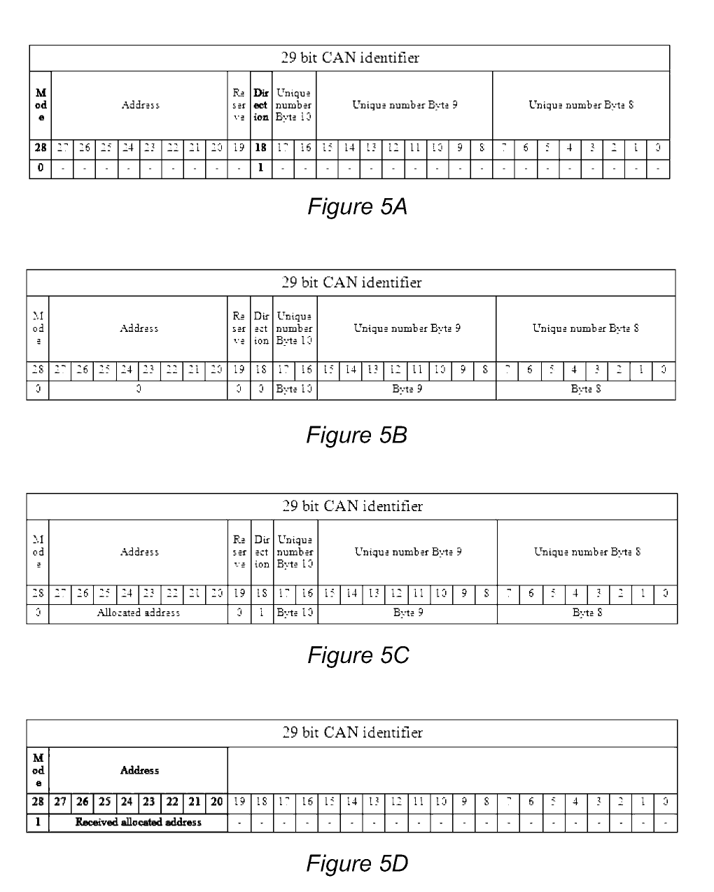

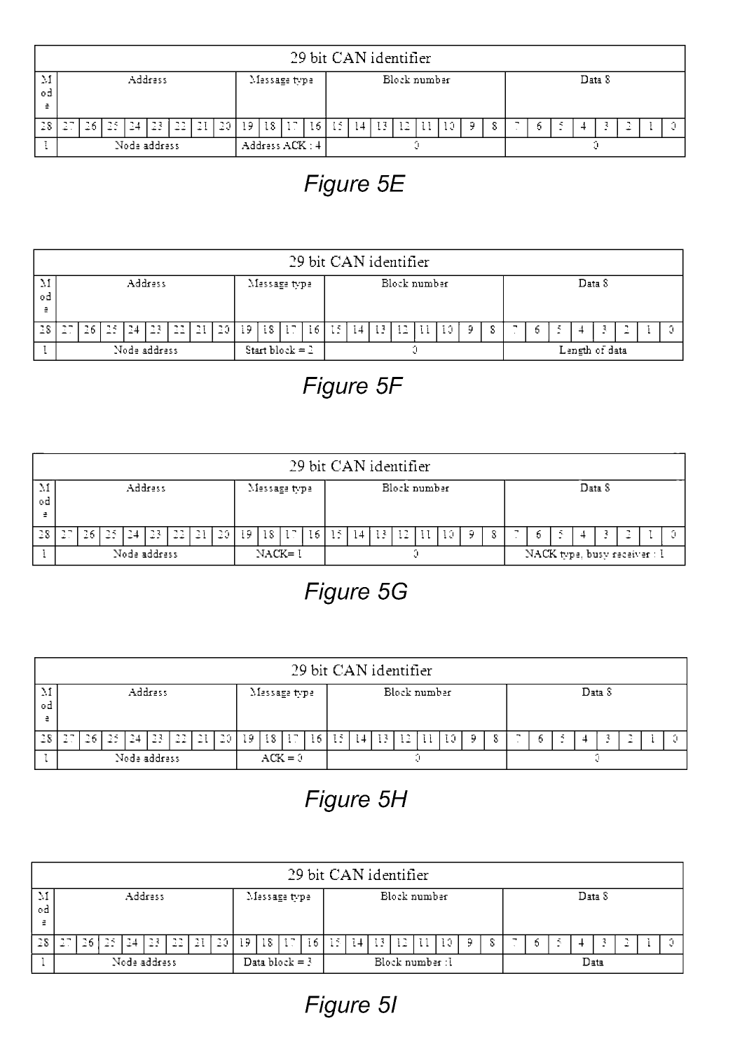

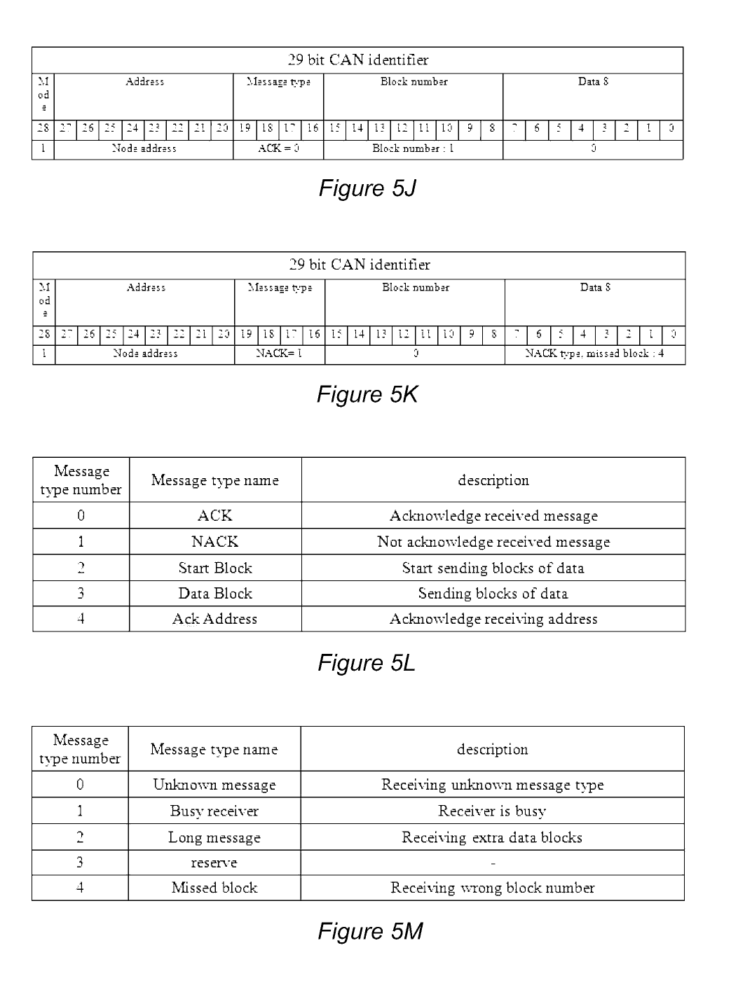

FIG. 5A depicts a 29 bit CAN identifier frame, where

Mode (Bit 28): 0=>Address allocation mode
1=>Data transfer mode

Direction (Bit 18): 0=>Message from Node to Hub
1=>Message from Hub to Node

3. Node generates a unique number. In an embodiment, the Unique number is 11 bytes (byte 0~byte 10) and Byte 10 only has 2 bit data.

4. Node send address request message in addition of unique number to hub.

FIG. 5B depicts the DB Node sending a frame to request an address, wherein +Unique number byte 7+Unique number byte 6+ . . . +unique number byte 0 is the format.

5. The DB Hub receives the message and conducts a search in pairing table for the existence of the unique number of the DB node.

6. If DB hub finds a unique number in the pairing table, the DB hub sends the existing address to the DB node.

7. If DB hub could not find the unique number, the DB hub allocates a new address and sends it to the new DB node.

FIG. 2C depicts the DB Hub sending a frame to provide the new address of the DB node which requested the address. The direction bit is set to ‘1’ as it was in FIG. 5A to show that the frame is moving from the DB Hub into the network. Also +Unique number byte 7+Unique number byte 6+ . . . +unique number byte 0, with the Mode (Bit 28): 0=>Address allocation mode and the Direction (Bit 18): 1=>Message from Hub to Node.

Note, in this embodiment, all messages in address allocation mode are single block CAN command. Each block of CAN command consists of 29 bit identifier and 8 byte data.

8. FIG. 5D depicts how the receiving DB node is allocated an address and sets the CAN filter to receive only messages with the received/allocated address. Where the Mode (Bit 28): 1=>Data transfer mode.

9. FIG. 5E depicts the format of a frame when the DB node sends an address allocation acknowledgment to the DB hub and in an embodiment sends it as a data transfer mode message.

10. The DB Hub saves/stores the node address as a paired node in a table. If the address is new, the DB hub also saves/stores the new unique identification number in the table.

II. Data Transfer Mode

In this embodiment, and in the data transfer mode, the DB hub and DB node can send different size messages RCP (Resource Control Protocol, as described in the U.S. Pat. No. 9,136,913) message in the CAN protocol embodiment. This mode is activated after the address allocation process is completed completely and the DB node can use the allocated address for sending and receiving messages as can any other node.

1. Source device (Node or Hub) sends a start block command to the addressed destination. This command consists of an address and a predetermined length of data, as depicted in FIG. 5F.

2. If the destination device is busy, the destination device sends an N acknowledge. The source device will then repeat the message later, as depicted in FIG. 5G.

3. If the destination device is ready to receive, the destination device sends acknowledge to the source device, as depicted in FIG. 5H.

4. The Source device sends a first block of data. Each block of data consists of the format: address, block number and 9 bytes of data, as depicted in FIG. 5I.

5. When the Destination device receives the block of data sent by the source device it sends acknowledge message. Acknowledge message consist of address and block number, as depicted in FIG. 5J.

6. If the block number order is not correct, the destination device sends a NACK (no-acknowledge) and the source device should restart the whole process, the format is depicted in FIG. 5K.

Steps 5 and 6 will repeat until the source device has sent all data to the destination device.

FIG. 5L depicts a list of message types in the data transfer mode and FIG. 5M depicts a list of NACK (no-acknowledgment) types.

After power up of a DB node which then connects to the DB hub, the process, in one embodiment is completed in less than one second. After 5 seconds the DB hub checks the table. If there is a node in the table which does not request an address, the DB hub can delete the old address from the table, thus in the case of a disconnected DB node there is a mechanism for removing that device from the network.

In further embodiment the proposed network has five operational modes:

I. Auto terminator or end of line (EOL) detection
II. Order detection and address allocation
III. connection detection or connect/disconnect detection
IV. Data transfer mode
V. Removing disconnect nodes

I Auto Terminator or End of Line (EOL) Detection

In this mode, node checks connection of next devices. If node is end of the line, node activates terminator and CAN bus is ready for data transfer.

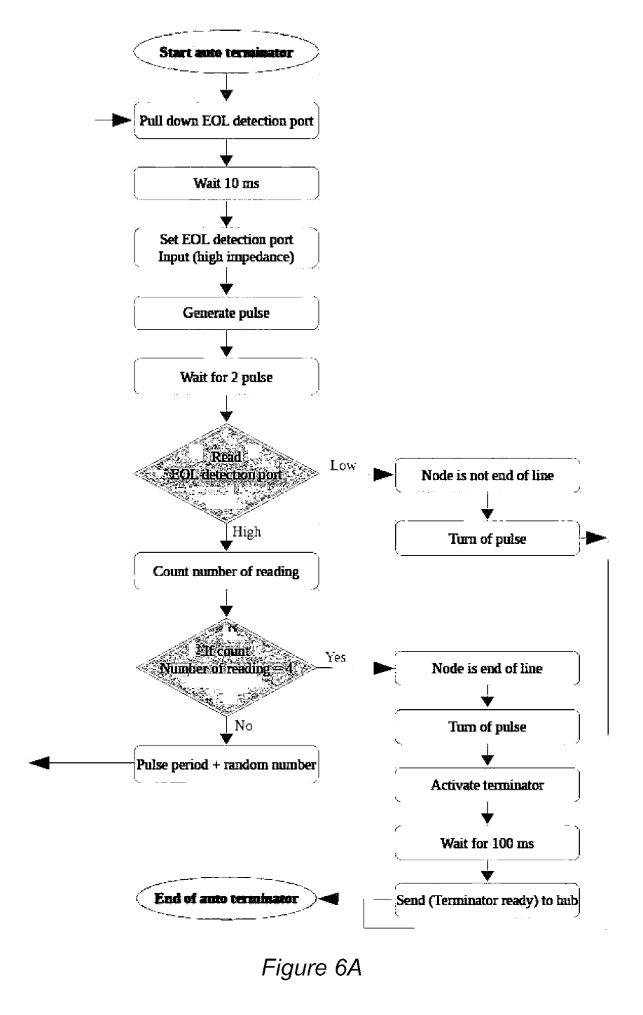

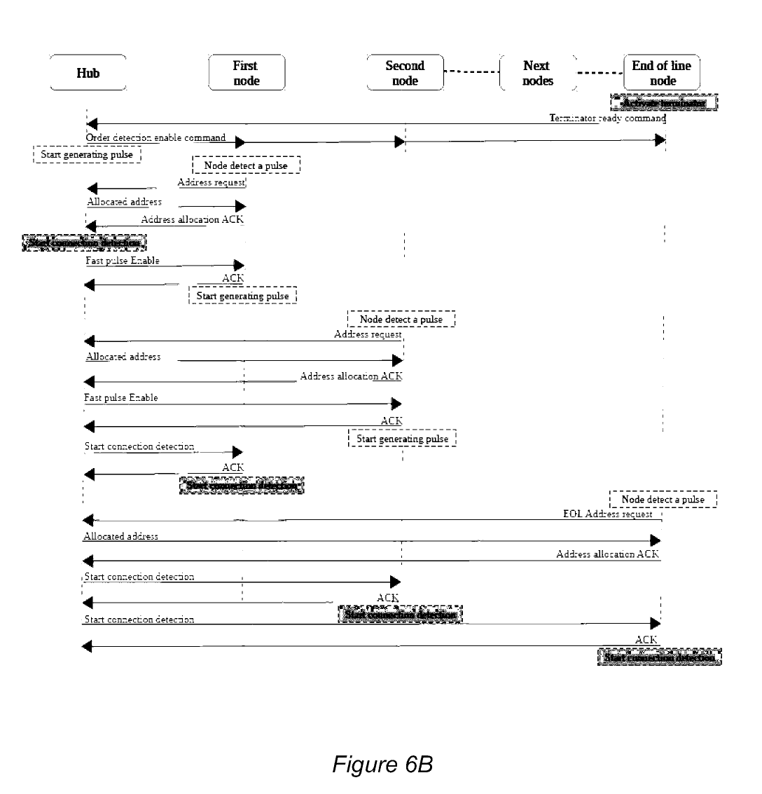

Auto terminator process steps are as below and depicted in FIG. 6A:

1. Node power up.

2. Node generates unique number. Unique number is 11 bytes (byte 0~byte 10) and Byte 10 has only 2 bit data.

3. Node pull down EOL detection port to de-charge the stabiliser capacitor and reset EOL detection port. (circuit to be described later in the specification)

4. After 10 milliseconds delay node set EOL detection port as an input (High impedance).

5. Node generates 30 Micro-second width pulse, with unique time period. Node uses unique number for calculating unique time period of pulse.

Pulse period=(unique number 0+unique number 1+ . . . +unique number 10+500)*30

Micro-sec pulse period is a time between 15 milliseconds to 90 milliseconds

6. After 2 pulse node reads the EOL detection port. If the port is low, it means both sides of that node have a device and that node is not at the end of the line. When a Node turns off the pulse and wait for the hub to start the order detection process.

7. If EOL detection port is high, it means that one side of node is not connected to another node on at least one side. But it is possible that pulse randomly is synchronous with pulse of other node. Therefore node repeats the process with a random pulse period.

8. Node adds pulse period with a 10 bit random number (0~1023) and generates pulse with a new random period.

New random pulse period=last pulse period+10 bit random number

9. If after 2 pulse node reads the EOL detection port again is the same as above. The node repeats this process 4 times if EOL detection port is high.

10. If after 4 time EOL detections the port still is high, the node is certainly at the end of the line and node turns off the pulse and activates a terminator node mechanism.

11. After activating terminator node mechanism the node waits for 100 milliseconds to make the CAN line stable. Then node send (Terminator ready) command to the hub.

II. Order Detection and Address Allocation

Hub starts order detection process after finishing auto terminator process and receiving (Terminator ready) command from end of line node. In order detection mode, nodes request an address from the hub according to their connection order (physical installation). A node which is next to the hub, starts requesting address. End of line node which have activated the terminator mode is the last node that requests an address. After the order detection process all nodes will have address and all devices are in connection detection mode and this process is depicted in FIG. 6B

The following steps are preformed to execute the order detection and address allocation process:

1. Node activate CAN filter to just receive messages from the hub (not from other nodes).

Mode (Bit 28): 0=>Address allocation mode (All messages before allocation address—node does not have address)

1=>Data transfer mode (All messages after allocation address)

Direction (Bit 18): 0=>Message from Node to Hub

1=>Message from Hub to Node

2. End of line node send (Terminator ready) command to hub.

Mode (Bit 28): 0=>Address allocation mode (All messages before allocation address—node does not have an address)

Com/Add (Bit 19): 0=>Bit 20~27 are Address
1=>Bit 20~27 are Command

Direction (Bit 18): 0=>Message from Node to Hub

Notice: this command just consists of 29 bit CAN identifier without a data byte.

3. Hub send (Order detection enable) command to all nodes.

Mode (Bit 28): 0=>Address allocation mode (All messages before allocation address—node does not have an address)

Com/Add (Bit 19): 1=>Bit 20~27 are Command

Direction (Bit 18): 1=>Message from Hub to Node

Notice: this command just consists of 29 bit CAN identifier without any data byte.

4. All nodes enable Order detection port. Nodes disconnect stabiliser capacitor and pulse generator from EOL detection port (as described elsewhere in the specification).

5. Nodes pull down EOL detection port to de charge the stabiliser capacitor and reset EOL detection port.

6. After 10 millisecond delay nodes set EOL detection port as an interrupt input (High impedance). Nodes are ready to detect order detection fast pulse from next device.

7. Hub start generating order detection fast pulse with 100 Hz frequency.

8. First node (next to hub) detects a pulse. Then the node sends an address request to the hub.

+Unique number byte 7+Unique number byte 6++unique number byte 0

Mode (Bit 28): 0=>Address allocation mode (All messages before allocation address—node does not have address)

Com/Add (Bit 19): 1=>Bit 20~ 27 are Command

Direction (Bit 18): 0=>Message from Node to Hub

Notice: this command consists of 29 bit CAN identifier and 8 bytes of data.

9. Hub receives the message and searches in the pairing table for an existing unique number. If the hub finds a unique number in the table, the hub sends an existing address to the node. If the hub does not find the unique number, the hub allocates a new unique address and sends it to the node.

+Unique number byte 7+Unique number byte 6++unique number byte 0

Mode (Bit 28): 0=>Address allocation mode (All messages before allocation address—node does not have an address)

Com/Add (Bit 19): 0=>Bit 20~27 are Address

Direction (Bit 18): 1=>Message from Hub to Node

Notice: this command consists of 29 bit CAN identifier and 8 bytes of data.
Notice: Hub sends back the same unique number as received in the address request.

10. Hub saves order number for node.

11. Node receives allocated address and sets the CAN filter to just receive messages with the received allocated address.

Mode (Bit 28): 1=>Data transfer mode (All messages after allocation address)

12. Node send address allocation acknowledge to the hub.

Mode (Bit 28): 1=>Data transfer mode (All messages after allocation address)

Notice: this command just consists of 29 bit CAN identifier without a data byte.

13. Hub saves the node address as a paired node in the table. If the address is new, hub also saves the new unique number in the table.

14. Hub turns of order detection fast pulse and starts connection detection process.

15. Hub send (Fast pulse enable) command to the first node.

Mode (Bit 28): 1=>Data transfer mode (All messages after allocation address)

Notice: this command just consists of 29 bit CAN identifier without any data byte.

16. Node Send data ACK message to hub

Mode (Bit 28): 1=>Data transfer mode (All messages after allocation address)

Notice: this command just consists of 29 bit CAN identifier without any data byte.

17. First node starts to generate an order detection pulse (Fast pulse) with 100 Hz frequency.

Next node detects an order detection pulse:

18. Next node detects a pulse and that next node sends an address request to the hub.

19. Hub and node execute the address allocation process in the same manner as the first node.

20. Hub sends a (Fast pulse enable) command to the node and the node sends back an ACK message the same as the first node.

21. Hub sends a (Start connection detection) command to the previous order node. Previous node sends back an ACK message to the hub.

Mode (Bit 28): 1=>Data transfer mode (All messages after allocation address)

Notice: this command just consists of 29 bit CAN identifier without any data byte.

End of line node, detect an order detection pulse:

22. Last node or end of line node detect a pulse. End of line node send (EOL address request) command to hub.

+Unique number byte 7+Unique number byte 6++unique number byte 0
Notice: this command consists of 29 bit CAN identifier and 8 bytes of data.

23. Hub and node execute the address allocation process in the same manner as other nodes. The hub does not send (Fast pulse enable) command to the end of line node because there is no other node beyond the last node.

24. Hub sends (Start connection detection) command to the previous node.

25. Hub sends (Start connection detection) command to the end of line node (last node).

26. Order detection and address allocation is finished and all nodes are in connection detection mode.

III. Connection Detection or Connect/Disconnect Detection:

After order detection and address allocation process, all devices (hub and nodes) start their own connection detection mode. In this mode devices generate pules with 30 Micro second width and 1 second period. The EOL detection port is low if the next node is connected. A rising edge on EOL detection port means the next node is disconnected and a falling edge means a new node is connected. In connection detection mode, devices can detect next node connection changes. If a device detects a disconnection, the hub should remove the disconnect node or nodes from the pairing table. If a device detects connection of a new node, the hub should do an order detection and address allocation for the new node or nodes.

Disconnect detection process steps are as below:

1. Device detects rising edge on EOL detection port. It means next node is disconnected.

2. If the device is node, node activate terminator circuit because node is end of line now. If The device is a hub, the hub continues to process from step (5) as described below.

3. If the device is node, sends (Disconnect detection) command to hub.

Mode (Bit 28): 1=>Data transfer mode (All messages after allocation address)

Notice: this command just consists of 29 bit CAN identifier without any data byte.

4. Hub sends back ACK message to the node.

Mode (Bit 28): 1=>Data transfer mode (All messages after allocation address)

Notice: this command just consists of 29 bit CAN identifier without any data byte.

5. Hub starts to check all paired nodes. The hub sends (Check connection) command to all nodes, one by one. If hub does not receive ACK message from a node, the hub removes that node from pairing table stored at the hub.

Connect detection process steps are as below:

1. If the device detects a falling edge on EOL detection port it means a new node is connected.

2. If the device is a node, the node releases the terminator because node is not end of line any more.

3. The new connected node or nodes start auto terminator process.

4. After finishing auto terminator process, the new end of line node sends a (Terminator ready) command to the hub.

5. Hub starts order detection and address allocation process for the new node or nodes.

6. Hub sends (Order detection enable) command. Nodes which already have address, could not receive this command because they previously set their CAN filter to just receive data transfer messages with their allocated address.

7. The new node or nodes receive (Order detection enable) command and start the order detection process.

8. Old devices are in connection detection mode and they are generating 1 second period pulses.

9. The first new node detects the mentioned pulses and sends an address request to the hub. Order detection and address allocation processes continue the way same as explained previously.

10. After finishing the order detection and address allocation for the new nodes, all devices are in connection detection mode and ready for data transfer.

IV. DATA Transfer Mode:

In this mode, hub and node can send different size messages (RCP message). This mode could be activate after the address allocation process is completed completely and the device can then use the allocated address for sending and receiving messages.

Data transfer mode steps are as below:

1) Source device sends start block command to destination device. This command consists the address and a length of data (bit 0~7).

2) If destination is busy, destination send N acknowledge. Source repeat message again later, where bit 0~7 is a NACK type.

3) If destination is ready to receive, destination send acknowledge.

4) Source sends first block of data. Each block of data consists address, block number (bit 8~15) and 9 bytes data. +Data byte 7+Data byte 6+ . . . +Data byte 0

5) Destination node receives the block of data and sends an acknowledge message. Acknowledge message consist of address and block number.

6) If the block number order is not correct, the destination node sends Not acknowledge and the source node should restart the process again. Bit 0~7 is NACK type.

7) This routine will continue until source device has sent all the data to the destination device.

V. Removing Disconnect Nodes

After power up nodes which already are connected to the hub, the address allocation process starts immediately. This process is very fast, and in an embodiment, within one second. After 5 seconds hub check the table is complete and if there is an old node in the table which does not request an address, the hub will delete that node from the table.

Discovery Bus (CAN) Commands Explanation:

I. Address Allocation Mode:

This mode consists of the exchange of messages and commands between a node and the hub before that, the node sets the CAN filter according to allocated address.
Mode (Bit 28): This bit indicates a message mode, between address allocation mode or data transfer mode.
0=>Address allocation mode (All messages before allocation address—node does not have address)
1=>Data transfer mode (All messages after allocation address)
Direction (Bit 18): This bit indicates a direction of message between hub and node.
0=>Message from Node to Hub
1=>Message from Hub to Node
Com/Add (Bit 19): This bit indicate that bit 20 to 27 (1 byte) are address or command

### 0=>Bit 20~27 are Address

### 1=>Bit 20~27 are Command

II. Data Transfer Mode:

After a node receives an allocated address from the hub, the node set CAN filer to just receive data transfer messages containing the allocated address.

Power on Process Explanation:

When node is in power off mode, it couldn't receive any command by CAN bus because, CAN line driver circuit is off. Therefore hub must send command by IRDA low power UART to turn on CAN line driver.

Power on process steps are as below:

1. Hub sends IRDA data by can line driver.

2. There is a detection circuit in the node to convert signals on CAN line driver to normal IRDA signals. The detection circuit uses timer 2 one pulse mode to generate suitable pulse width.

IRDA pulse width=(1/Baud rate)*(3/16)

Baud rate=9600 bps
IRDA pulse width=19.5 Micro seconds

3. Detection circuit also generate an interrupt to turn on the node's CPU from low power mode.

4. Hub sends 4 bytes to turn ON node.

5. First hub sends a 2 byte preamble to the node. The two bytes are enough time for the CPU to wake up from low power mode. Preamble data is number 255. This number for IRDA is just one positive pulse (start bit) because for IRDA logic one is 0 volt (ground).

6. Third byte is the address of the node.

7. Forth byte is an inversion of the address for CRC checking the command.

Forth byte=255−address

8. If node receives all bytes correctly, the node checks the address and forth byte. If the received address is correct, the node turns on the CAN line driver and the CPU stays in wake up mode and stay ON.

9. If the command is not complete or the address is not correct, the node will again turn to sleep mode.

The following circuit and functionality is included in all of the DB devices, the DB hub and DB node/s since it provides the capability to change the state of one or more of the functional blocks (typically chips) of the DB hub or DB node from a low power consumption state to another state in which an appropriate function can be performed, and further from which other power consumptions states can be transitioned. Ideally, all the DB nodes are in a low (minimum consumption) power state while not in use, especially since many such sensors will be powered by a small battery, having mA hour capacity at low volts say 1.5 volts. Such a low capacity power source would be drained very quickly if the DB node did not have a low power state, into which the DB node can be placed the majority of time. In fact the ability of the DB node to be woken up when required or be able to wake itself up when required ensures that the power supply 302 (from FIG. 3) will be used minimally and thus it can be sufficient to only provide a low power capacity power cell in the design phase. Some nodes will have the ability to be powered from an external source, such as from the wires, which can have a pair of the typically multiple pairs of wires carry power for just this purpose, or from a further external supply such as a solar photo voltaic (PV) panel and associated regulator, or even the mains if it available, but none of the alternatives are assumed.

Referring to an embodiment of a DB Hub disclosed in FIG. 2, wakeup circuit 200 detect when a preliminary pulse or predetermined pulsed data is present on the bus and forwards a wakeup signal, Wakeup1 to the application processor 206 (central processing unit), which is often in sleep mode to reduce power consumption, which is a recognised minimum power consumption state/mode. Receipt by the Wakeup1 signal from the wakeup circuit, causes a wakeup interrupt (a signal/voltage applied to a pin of a relevant central processing unit chip) to bring the processor out of ‘sleep’ mode (minimum power consumption mode) i.e. into the ON mode. Wakeup1 could be one or more pulses and could also represent a device address. If it is a device address, the application processor wakes up, compares the address to its own address. If they match, the application processor remains awake to execute further commands as the firmware or protocol requires. If the address does not match the devices own address, the application processor will immediately go back to sleep to conserve power.

The application processor 206 can communicate with optional sensor 207, to provide data to other devices, or other parts or and devices in the network via various communication mediums. An optional CAN Processor 208 may exist which handles the CAN protocol and communicates to the CAN Transceiver 209. The application processor and the CAN processor may be a single processor. Once the application processor 206 is awake and it is determined to be necessary to communicate to another device over the wire signal communication mechanism (bus) using a particular signalling protocol and devices, the application processor will send wakeup signal Wakeup2 to wake the CAN Processor (or when the CAN processor is an executable file stored in the memory (MEM) associated with the application processor) and at the same time or with any appropriate delay, a wakeup signal Wakeup3 is generated by the application processor and sent to the CAN transceiver circuits 209, enabling communication over the bus 211, of whatever data is generated by the sensor 207 (FIG. 2).

When communication is complete, all circuits other than the Wakeup circuit (which does not have any power consumption, or extremely low power consumption, while waiting to receive pulse/s) and necessary Power supplies 210 will enter low power, shutdown or stop modes to conserve power.

The DB Hub comprises an optional NFC/BLE (Bluetooth Low Energy) circuit 201 that communicates to an optional Auto Discovery Remote Control (ADRC) circuits 203 that manages network communications that allow the DB hub to be incorporated into additional networks using the Auto Discovery Remote Control method, as described in the incorporated patent document. These optional circuits are also capable of being powered up from a low power consumption state.

As described associated with FIG. 1, the DB hub can communicate external of the DB network using Wi-Fi radio 204 and associated Antenna 205 (as shown on FIG. 2). Thus as depicted DB Hubs 1, 2 . . . n 105 can connect wirelessly using wireless link 104, to a Gateway 102 which can then communicate to a remote monitoring centre 100 over the Internet 101. Wireless link 104 may be 802.15.4 or 802.11 for example, or may be a wired interface.

FIG. 3 depicts an embodiment of a DB Node device of the DB network connected to the wired transport 300 which by way of example can use the CAN bus protocol. Wakeup circuits 304 detect when data is present on the bus (that data may include the address of the node to which the following data is intended) and once processed by the wakeup circuit, a wakeup signal, Wakeup IP 2, is presented to the application processor 306 (central processing unit) which has associated digital data memory element MEM (which may be internal to the CPU or external or both). The application processor is typically in sleep mode to reduce power consumption. Wakeup IP 2 signal causes a wakeup interrupt (a known signal applied to a typically dedicated pin of the application processor) to bring the processor out of sleep mode, i.e. into the ON mode. Wakeup IP 2 signal could be one or more pulses and could represent a device address. If it is a device address, the application processor wakes up, compares the address to its own address. If they match, the application processor remains awake to execute further commands as the firmware located in the memory MEM or protocol requires. If the address does not match the devices' own address, the application processor will immediately go back to sleep to conserve power.

The application processor 306 communicates with sensor arrangement 308 (a DB node could have an associated sensor, be an actuator, have both a sensor and an actuator, and in this embodiment it only has a sensor) to provide data to other devices using the protocol and wire signal communication medium 300 (sometimes referred to as the bus). The sensor can provide data which is specific to the type of sensor that it is. The sensor is adapted to provide signal/data to the processor as and when required so that the node performs the function required. The sensor arrangement may not just sense, it may also be an actuator such as for example a door opening device, a light switching circuit, a controller of any needed machine, device, etc.

In an embodiment, a CAN Processor 309 handles the CAN protocol and communicates to the CAN Transceiver 310. The application processor and the CAN processor may be a single processor or node which has been tapped into the wires 300 and are woken up by respective Wakeup signals Wakeup1 and Wakeup2 as generated by the application processor 306 to enable communication over the bus 300. Once communication is complete, all circuits other than the Wakeup circuit 304 and the power supply 302 will enter low power, shutdown or stop mode to conserve power.

The DB node in this embodiment has power supply 302 which is of the same nature as the power supply described in relation to the DB hub, which is sized to suit long term very low power consumption by the DB node. Power may however be supplied direct from the bus, it may comprise a battery source, which is charged from an external or local supply of current. There are numerous configurations and arrangements for suppling power and in situations where there is only a small power capacity available, the use of the wakeup arrangement assists to conserve the small amount of power that is available.

Part of the functionality of the DB node, in an embodiment, is its ability to be connected to the wire signal communication mechanism 300 and be discovered by other devices (the DB hub and/or one or more DB nodes and the remote server) also connected to the wire signal communication mechanism.

The general steps associated with the discovery are as follow, and a more detailed version using as an embodiment the CAN protocol over the wire signal communication medium:

Node attaches onto the wire signal communication medium, in this embodiment a pair of wires

Power can be supplied over the cable to the node.

### Node Powers Up

Node sends Unique ID (UID) to the DB hub

In the embodied implementation the UID is a 32 bit CRC of data built into each microcontroller of the DB node which is guaranteed by the manufacturer to be unique to each device.

The DB hub looks up if UID is known in it memory.

If not known

DB hub assigns next available subunit ID to that device and records the UID and subunit ID in local non-volatile memory.

Get number of files in device

In the embodied implementation, the Resource Management File (RMF) ‘files’ are built into the DB node devices' program code.

For each file

Get name of file
Get hash of file from node

In the current implementation the hash is a 32 bit CRC of the file contents.

If file exists in DB hub file system

Compare hash to the version of it in the DB hub or alternatively in the remote server file system

If hashes differ or file does not exist

Get file from device and store in DB hub file system.

This then allows the whole network to be provided the relevant file of the new DB node, and as well the remote server, and thus the particular functionality of the DB node. As described previously the DB node could be a temperature sensor, it could be a door actuator, etc. and now the device is known and thus self-discovered to all of the connected DB devices in the network.

If any files written or UID was unknown

Send signal to DB Hub to indicate that device configuration has changed DB Hub starts enumeration process with remote server in the same way as normal ADRC pairing

Any further communication with the node uses the network address of the DB hub and the subunit ID of the DB node to uniquely identify it.

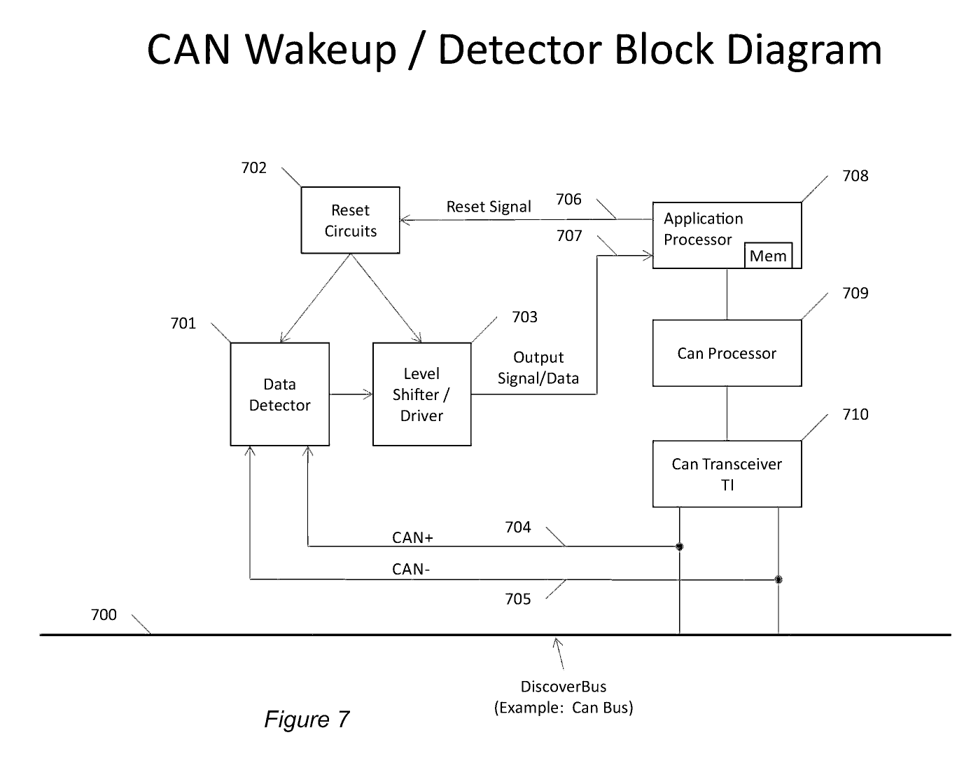

FIG. 7 represents a block diagram of a Detector circuit that monitors activity on the wire signal communication medium 700 in the embodiments provided, thus far a CAN bus, the triggered output signal of which wakes up the application processor of a DB node, DB sub-node or DB hub as is depicted in FIGS. 2, 3 and 4.

In an embodiment, CAN bus 700 is a 2-wire interface consisting of CAN+ Signal 704 and CAN− Signal 705 operating as a differential pair. When a data bit is transmitted on the CAN bus, the CAN+ data line is pulsed/driven a predetermined amount above a nominal voltage and the CAN− data line is pulsed/driven a predetermined amount below a nominal voltage. These data pulses provide a voltage difference between CAN+ and CAN− during the bit transfer period and is detected by a Difference/Data Detector Circuit 701. The output of the Difference/Data Detector Circuit drives a Level Shifter/Driver 703 that is used to square up the detector output signal, level shift it to a predetermined amount and/or increase the drive output capacity. The final Output Signal/Data 707 is suitable to interface to a microprocessor or other circuits as required, which as described in the embodiment is an application processor, but could alternatively be a digital signal processor or discrete circuit.

Where ultra-low power implementations (of the level of about 50 micro-amp or less currents) of the Data Detector 701 or Level Shifter 703 are required, the response time of the circuit is severely slowed due to very high impedance biasing of components. Transistors such as Metal-Oxide-Semiconductor Field-Effect Transistors (MOSFETS's) are often selected as detect and switching elements over Bipolar Junction Transistors' (BJT's) as they require no wasteful base current to switch. However, due to the MOSFET's inherent input and output capacitance, their turnoff and settling times can be very long when coupled with high value biasing resistors. As a result, slow data pulses on transport 700 could be used to wake up the micro, however high speed pulses or data would not be able to be decoded as the settling times of the Data Detector would likely be much longer than the time between data bits. To overcome this potentially long settling time of the Data Detector, it is possible that once the circuits have switched, the Output Signal 707 can then be used as an interrupt into a microprocessor (such as the application processor) that is then used to generate a reset signal 706. The Reset Circuits 702 can switch any slow responding circuit nodes in the Data Detector and Level Shifter back to their nominal steady state voltage levels, making these circuits ready to receive the next bit, speeding up the circuit response time and allowing even high speed data bits to be processed by the application processor.

Thus a CAN data bit can be detected; a corresponding Output Signal is generated, triggering a microprocessor or other circuits to generate a Reset Signal, resetting all circuits making them ready to be triggered again by the next CAN data bit.

The increased speed of this ultra-low power Detector allows multiple signal pulses to be transferred down the CAN bus allowing data such as node identifiers/addresses to be transmitted along the wiring in this embodiment CAN bus structured wiring. These addresses can be used to individually address and wakeup individual nodes. This further reduces power consumption over the current state of the art which requires the CAN transceivers on all nodes to be powered in either full ON or sleep mode which can consume milliamps or 10's of micro-amps for each node. Comparatively, the Detector circuit described here, in broad functional terms, can be designed to consume less than a micro-amp and as low as tens or hundreds of nano-amps. Thus each node can completely power down the CAN transceiver and use the Wakeup circuit described as an “out of band” communication receiver. The total power consumption saved can be significant in implementations that utilise a large number of CAN DB nodes, as all CAN transceivers can be completely powered OFF. If a DB node needs to communicate to another node (or all other DB nodes in that DB network), it turns on its CAN transceiver and transmits the Wakeup Signal/Address Data. This signal is then detected by the microprocessor in each of the nodes. The micro/circuits in each node wake-up, process the signal/address and determines if the data is for itself, meaning that if the address is not that nodes address, that node will immediately go back to minimum power mode thus saving power. If the data is for itself (its own node), the CAN transceiver is turned ON and all subsequent data transfers are then communicated using traditional CAN protocol. Once the data transfer is complete the CAN transceiver is turned off again, the micro goes into sleep mode and the process is ready to be triggered again with a CAN bus signal.

Clearly it would also be possible to implement an ultra-low CAN Pulse transmitter, however, the power saving benefit in this invention is that all CAN transceiver nodes can be OFF, rather than ON or in sleep mode. A lesser benefit is gained from the transmitting node using an ultra-low power transmitter considering the CAN transceiver will need to be turned on anyway to complete the full data transfer once the Wakeup signalling is complete.

It would also be possible to implement address filtering in the Data Detector 701 so that all the application processors in all of the nodes would not be woken up, but only a single application processor in an addressed node would be interrupted to wake up. However the designer of the system would need to weigh up the additional power consumption draw of the additional address processing circuits in the Data Detector, which are always on and ready to decode data on bus 700, compared to all application processors waking up on all data communications on the bus. The main factor to consider is the duty cycle of data to no data on bus 700. If data is regularly transmitted it may be advantageous to filter on an address and wakeup a single application processor. These decisions clearly fall on the designer of the system and the power consumption target required to be achieved.

One such circuit implementation would show CAN signals CAN+ and CAN− couple to a Data Detector transistor or comparator via capacitors. Resistors would level shift the signals to ground GND, while diodes are used to provide transient protection, limiting the signals to a diode drop above the power supply and below GND.

A transistor or comparator is used to provide a Level Shifter/Driver stage producing the Output Signal/Data. This level is suitable for direct input to a microprocessor or other circuits.

The Reset Circuits 702 provide the necessary drive signals to various transistors or switching elements to reset all slow settling nodes in the Data Detector 701 and Level Shifter 703.

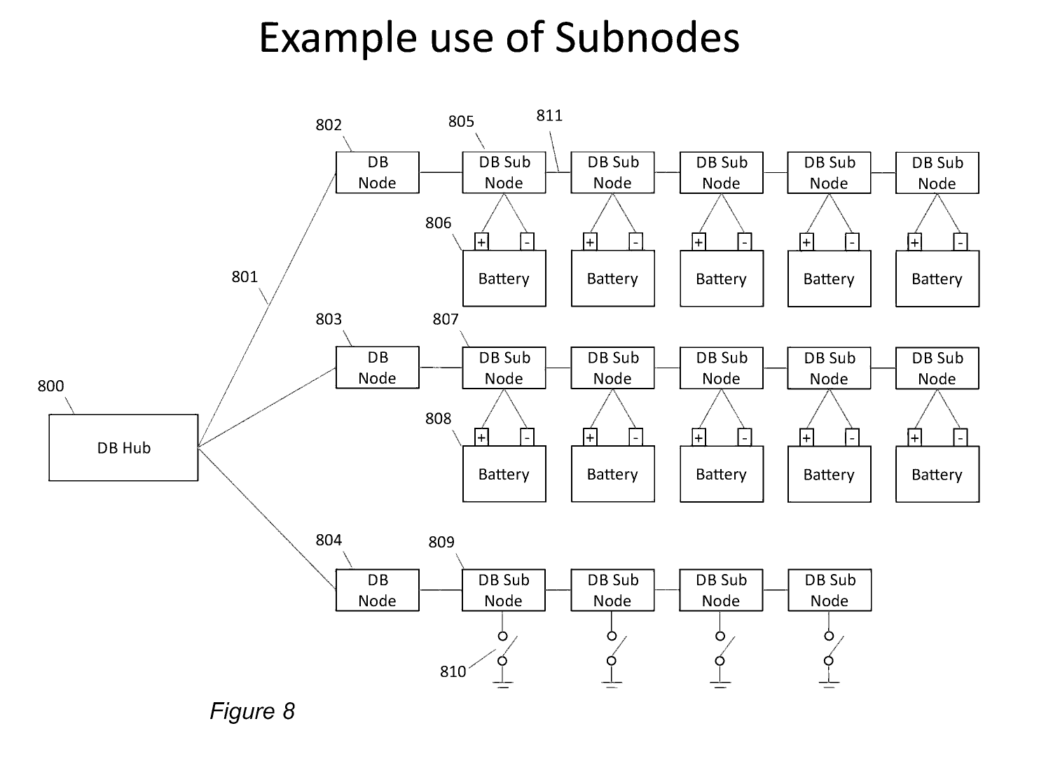

FIG. 8 depicts an example of a network hierarchy comprising a DB hub 800, DB nodes 802, 803, 804 and DB sub-node 805 associated with DB node 802, DB sub-node 807 associated with DB node 803, and DB sub-node 809 associated with DB node 804. Often in data centres, large arrays of batteries are used to provide emergency power backup when the supply grid power fails. Due to the large number of batteries involved, it is desirable to reduce the cost of individual battery monitoring nodes. To create a network of the type that will support the needs of low capacity data transfer between, a large quantity of dispersed sensors and actuators, it is economical to use low cost data transceivers as the transmission distances and data volumes and data rates are low. LIN, SMBus and the like could be good choices for the local transport wires 811 which connect DB sub-nodes in the 805 series of identities. In this embodiment, low cost DB sub-nodes 805 can be pre-set to periodically monitor the condition of each the battery 806 in the battery array, with the sensor designed to measure/sense voltage, current, impedance, etc. The DB sub-node could consist of a single, low cost central processing unit (possibly with on-board memory to store and executable for the chosen protocol, say SMBus) and a transceiver suitable for the wire signal communication medium 811. Each DB sub-node can then transmit data representative of the sensed measurements or the raw data collected by the sensor onto to the wire signal communication medium 811 where DB node 802 will receive and collate data as required. DB node 802 also contains single, low cost central processing unit (possibly with on-board memory to store and executable for the chosen protocols, say SMBus for the connection to the SMBus and CAN for transfer of the data on the wire signal communication medium 801 to DB Hub 800 for further processing or further retransmission. The wire signal communication medium 801 is different to wire signal communication medium 811 and more chosen so as to provide longer range and higher data bandwidth.

Additional battery strings 808 can be supported by using another DB node 803 and associated DB sub-nodes 807. To further illustrate the network configurability and flexibility, a set of dry contacts 810, which may represent door open sensors, and each sensor can be monitored with a low cost DB sub-node and providing an alert to node 804 and subsequently to DB hub 800, when a contact open or close event occurs.

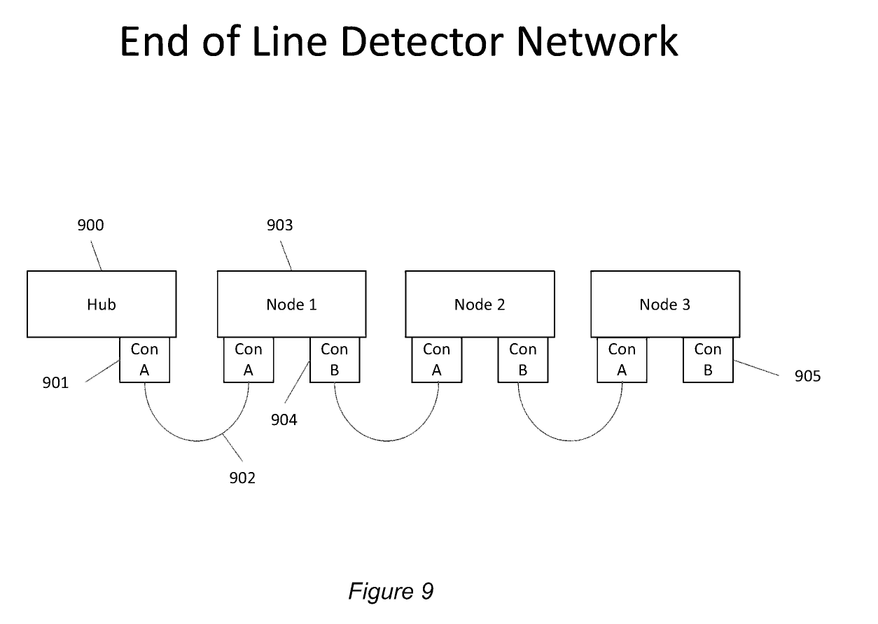

As depicted in FIG. 9, as shown to be within a network as depicted in FIG. 1 there is also preferably a circuit for automatically enabling a terminating element when the DB device is the last device in a serially connected network of DB devices. In such an instance a DB device can be equipped with a circuit to determine if there are adjacent devices connected on the network. One or more pulses of voltage or current can be applied to the network either on power up or as required during operation. Voltage or current level measurements can be made to the network at a predetermined time during or after the pulses, and circuits or algorithms determine, based on the measurements, whether adjacent devices are present/connected. If it is determined that an adjacent device is not present, it is often a requirement to connect a terminator. In this aspect, the device is equipped with circuits to switch in a terminator network when it has been determined there is no adjacent device; that is, the device is located at the end of the network wiring. The benefits include eliminating the need for an installer of the network to manually determine, install or switch in terminators where necessary.

In larger networks consisting of many devices, it is inevitable that long wire signal communication mediums, such as cable runs, are necessary. It is often necessary or beneficial to power the network from a battery supply. Often small batteries such as coin cell, CR123, AAA sized batteries, etc. are utilised, and have both low capacity and low voltage. In the case of networks consisting of a small number of devices or devices that are wired together within a close geographical location using short cables, such as in a computer room or home, these small capacity batteries can power the network based on the disclosure provided so far. However when a network consists of one or more nodes that have high current drain, or are connected using long cables, there may be insufficient voltage due to cable losses to operate a device and in severe cases the high current draw can render the entire network inoperable. In these circumstances it can be beneficial to have the ability to provide a secondary higher voltage supply. This supply may be a solar panel, plug pack, etc. A solar panel can provide a higher voltage supply during appropriate environmental conditions. This supply may have the ability to “top up” or back feed the primary low voltage or lower power supply when necessary or when available, maintaining the operation of the network. This supply may be applied locally to a device to supply a high power need specific to that device, or the supply can be run as a secondary line down the network cable making it available for other devices.

Additionally it is beneficial where a secondary supply is applied to a node and where that supply is used to “top up” or back feed the primary or other supply of the network, that in the case of an over voltage or other damaging supply voltage condition that the secondary supply is switched off or limited, or the back feed capability turned off, so as to minimise any potential damage to the rest of the network.

Furthermore to protect the integrity of a low power network, where the supply to the network may be of low capacity or high impedance, devices should be designed to limit their initial start-up currents, as plugging such devices into the network may cause power droops/brownouts in the system, potentially resetting other devices on the network or cause devices to malfunction. As such it is beneficial to include a soft start capabilities on devices such that on power up, when the device is plugged into the network, current surges are minimised. Reducing the start-up currents can be achieved through; utilising soft start circuits in the power supplies of the device; employing software and firmware techniques that progressively power up the device's peripherals and subsystems; or providing an external and locally provided power source to the device, minimising the power draw from the network supplied power.

In another aspect, a device is equipped with circuits that can determine if the low voltage supply is below a predetermined level and cause an action such as, alert other devices, or the network operator, and where available, automatically switch to a higher voltage/power or secondary supply. The device may contain circuits that provide the ability to automatically disconnect the device's load from the low voltage supply when the high voltage supply is present, reducing the load on the low voltage supply.

Additionally it may be beneficial to protect the device from overvoltage events. These events can occur during installation when an installer may plug in an incorrect cable. This is possible with RJ45 connectors and Cat 5 and Cat 6 twisted cables being commonplace in networks. Additionally Power over Ethernet (POE) is being readily used with numerous pin-out standards being utilised, thus enabling high voltages, above 40 volts, to be present on multiple possible pins on the connector. With, for example, Cat 5 and Cat 6 cables becoming commonplace across many networks, the chances of inadvertently applying an overvoltage to a device is increasing. Additionally, overvoltage events can occur when a power supply is sourced by an unregulated solar panel that is exposed to extreme weather conditions. In these cases it is beneficial to protect the device, yet have the device continue to operate, and alert the network operator. This type of functionality can be implemented utilising resettable fuses that enter a high resistance state when an overvoltage event occurs. In this state, current can still pass and if carefully designed, voltage detection and switching circuits can be utilised with a fuse of this type to allow the device to continue to operate safely, even during overvoltage conditions. In the case where multiple supply lines are utilised on the network, an overvoltage event, occurring on one of the supply lines, should be prevented from being fed into another supply line, isolating the fault. Hence in another aspect, a device is equipped with overvoltage detection and protection circuits that automatically react to overvoltage events to maintain a safe supply to a device, thus allowing continued device and network operation.

FIG. 9 depicts an arrangement of devices (DB Hub and DB nodes) connected together serially with wired bus 902.

The DB Hub 900 depicts a device that is connected to the beginning of the serial connection. It may operate stand alone, or a network of devices can be formed by adding a device to its connector Con A 901. In this example, Node 1 903 is connected to the DB Hub 900 through wire 902 which connects DB Hub Con A with Node 1 Con A via wire connection 902. Another device can be added to the network by connecting a wired connection to Node 1 Con B. In this way further devices can then be added by connecting by looping together in a serial manner.

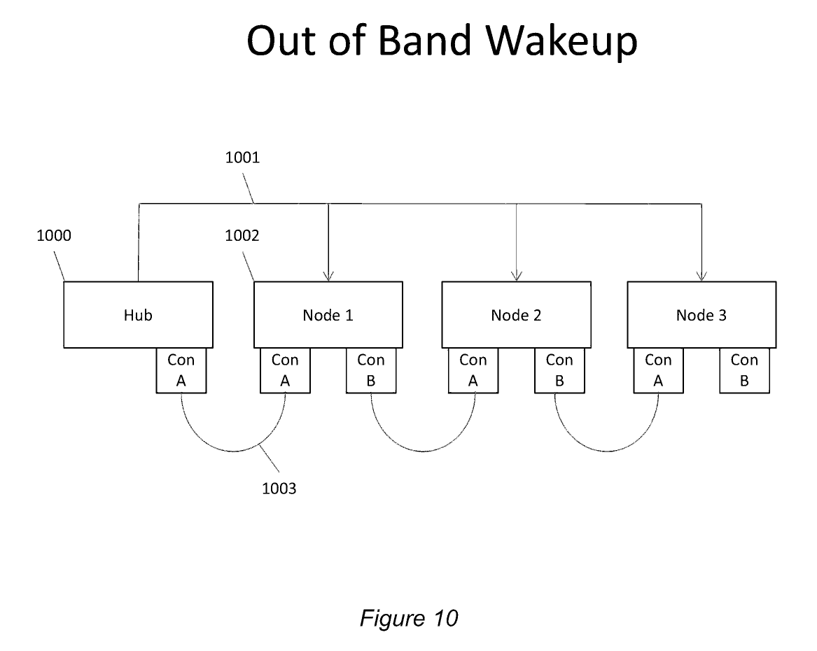

FIG. 10 shows a similar arrangement of devices where hub 1000, node 1 1002 and subsequent nodes are connected serially using wired connection 1003. Additionally though this arrangement also shows an out of band communications mechanism 1001. This can be another wired bus that is not normally part of the normal communications channel of wired connection 1003. It could be a single wire, collection of wires or bus, including optical transport such as a single wire, differential pair, data over power line, fibre optic, 1-Wire communications bus, etc. It can be dedicated to waking up the application processors in the attached nodes. Additionally the out of band communication mechanism 1001 could be a wireless communication mechanism, including 802.15.4, 802.11, Bluetooth, of the form of BLE, BLE Mesh, a Bluetooth beacon, or the like. Additionally, the out of band signalling could utilise audio signals (subsonic or supersonic), near field (such as NFC) or electromagnetic pulses or data stream, in fact any such mechanism that is considered out of band from the normal data communications connection. Additionally, the normal data communications channel itself can be turned off/powered down, in that all the devices are in OFF mode and therefore the channel is non operable to normal data transfer at this time. For the example of CAN bus, rather that the CAN+ and CAN− lines being at half rail voltage, they could be at ground potential. Data transmitted on this data communications channel while in this low power or OFF mode, can also be considered out of band. In this way the nodes can be in a low power sleep or OFF state and a wake up interrupt generated from the out of band signal to cause the application processor to come out of the low power mode into a normal operating mode, enabling any bus transceivers where necessary to then allow communication using the wired connection 1003.

Referring to FIGS. 9 and 10, this wired connection 902 and 1003 respectively may be a data communication bus such as CAN bus, SMBus, or the like and may include power distribution, ground, data lines and end of line determination connections.

Circuits within each device determine if the device has one or two adjoining neighbours.

In the case of the DB Hub, it has only one connector and these circuits can determine if it has one neighbour attached or nothing attached. This determination may then be used to affect the behaviour of the DB Hub if desired.

Node 1 and Node 2 have devices connected to their respective Con A and Con B connectors. In the case of Node 3, its Con A is connected to the neighbouring Node 2 device's Con B, but nothing is attached to Node 3's Con B, therefore it is classed as the end of line (EOL). Thus, by making a determination whether a device is at the end of the line or not, its behaviour can be changed to reflect its position in the network.

For example, if the wired network is CAN bus, then it is a requirement to add a terminator to the last node of the bus. In this case if Node 3 is determined to be the end of the line, then circuits could automatically add a terminator to its Con B. This would eliminate the possibility of installer error, where a terminator may be omitted resulting in unstable network operation.

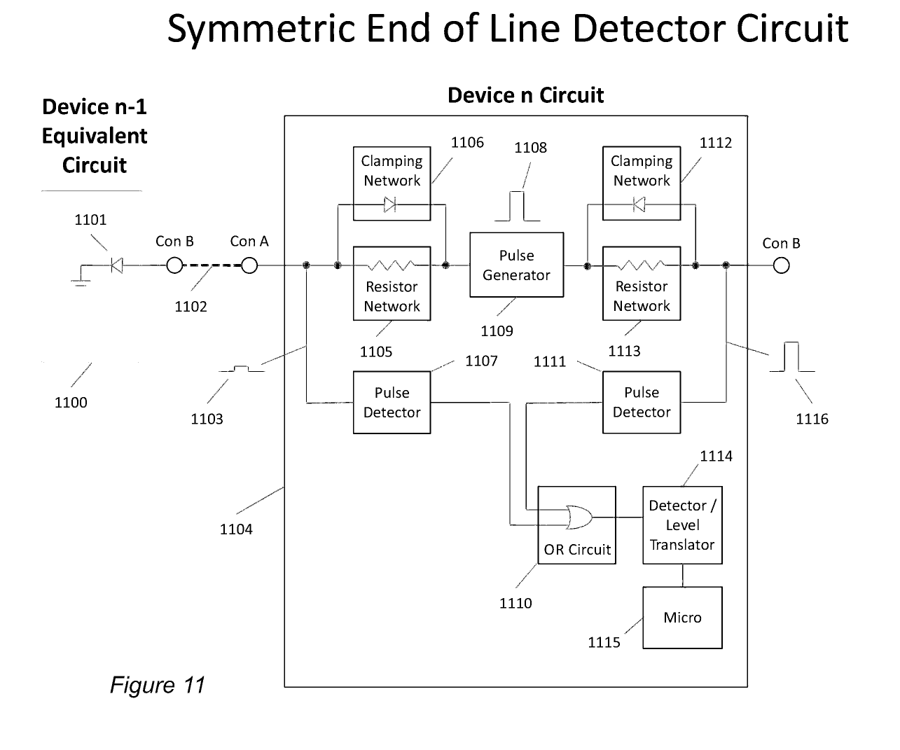

There is considerable advantage if Con A and Con B of each of the Nodes are identical in functionality, as opposed to being predefined, such that one is an input connector and one is an output connector. Although product labelling can provide a guide to installers, it is fail safe, if an installer can daisy chain wiring irrespective of which connector is used as the in or out. It is this aspect of connector symmetry in conjunction with end of line detection that is disclosed in the specification and is described in more detail referring to FIG. 11.

FIG. 11 depict an example of the elements that can be used to form a symmetrical end of line detection (EOL) circuit in a device that is part of a device network, in an example, DB nodes.

Device n is equipped with 2 connector terminals, represented in this example as two separate connectors, Connector Con A and Connector Con B. It is via these terminals that adjacent devices are connected to their respective symmetrical end of line detection circuits.

Device n is connected to an adjacent device n−1 via wired connection 1102 between Con A of Device n and Con B of Device n−1.

The general principle of operation is that the circuit output state changes and is detected, when a device has one or two neighbours present, thus allowing a device to change its mode of operation determined by whether it is positioned at the end of line or not.

The Pulse Generator 1109 is used to generate pulses 1108. The output is driven to ground between pulses. The width and repeat period of these pulses is designed to satisfy the balance between the lengths of wires between devices, the power consumption limits and output state change times. Wider pulses will support longer wire runs as they overcome larger cable capacitances, but will dissipate more power due to larger resistive losses in the system. The added power consumption of wider pulses can be offset by increasing the time between pulses, thus reducing the pulse duty cycle. However, larger times between pulses results in a longer time for the detection of a state change if an adjacent device is added or removed.

Pulse 1108 is fed into identical Resistor Networks 1105 and 1113. Each resistor network has parallel Clamping Networks 1106 and 1112, represented as diodes in this case. The cathode of each of these diodes is connected to the Pulse Generator and the anode of each diode is connected to connector Con A and Con B.

Device n−1 has an equivalent circuit shown as diode 1101 clamped to ground. Although the full end of line circuit in Device n−1 is identical to Device n, for the sake of explanation in this case, it can be reduced to a single diode clamped to ground. This is the case during the time when Device n−1's pulse generator circuit is not driving a pulse, as at this time it is driving to ground, which is the state of the pulse generator for the majority of the time, if the duty cycle of pulses is very low.

Therefore, when neighbouring Device n−1 is connected to Device n's Con A, Device n−1 clamps the pulse 1103 to a diode drop forward voltage level above ground. The Resistor Network 1105 provides isolation between Pulse Generator 1109 and the effective short to ground at Con A, as a result of Device n−1 being present. At this time Clamping Network 1106 in Device n has no effect as it is reverse biased. Yet it is this same diode network that shorts the pulse generated from a neighbouring connected node.

For further illustration, Con B on Device n has no adjacent node connected. As such, Con B of device n is not clamped and free to swing as determined by Pulse Generator 1109. Thus in this example, Pulse Detector 1107 cannot detect clamped Pulse 1103, while Pulse Detector 1111 detects Pulse 1116. The outputs of both pulse detectors are fed into an OR Circuit 1110. Therefore, if either pulse detector detects pulses, the output of the OR circuit will be active, indicating the device is end of line. By further explanation, if a further device was to be connected to Device n Con B, then Pulse 1116 would also be clamped. At this point the output of the OR circuit would be deactivated, indicating the node is not at the end of the line, but in fact has two neighbours.

The output of the OR 1110 circuit can then feed into an optional Detector/Level translator 1114 which can then condition the signal suitable for microprocessor Micro 1115 or some other circuit. It is possible that a number of these separate elements may be combined into a single chip or circuit. For example, two or more of the Pulse Detectors 1107 and 1111, Pulse Generator 1109, OR circuit 1110, Detector/Level translator 1114, or Micro 1115 may exist in a single chip.

Each node in the system is generating pulses from time to time to determine if it is end of line. When the pulse generator of device n−1 generates a pulse, the effective diode clamping is removed. Thus if Node n's pulse 1108 is generated at the same time as device n−1's pulse, then the pulse 1103 will not be clamped providing an effective false end of line detect signal out of the OR circuit 1110 (or similarly detection circuit). To minimise the probability of two adjacent nodes pulsing at the same time, it is beneficial to have a very low duty cycle for the pulses, either through the use of very narrow pulses and/or a very long pulse repeat period. Duty cycles in the order of 1:5000 or 1:10,000 will significantly reduce the probability of pulse collision. If the duty cycle of the pulses is very low, then filtering can be applied to these signals to eliminate these false triggers, particularly if there is one or two false triggers events occurring occasionally. This filtering also improved noise immunity of the circuit in case random noise pulses falsely trip an end of line detect output. This filter could be implemented as a discrete circuit as part of the Detector/Level translator circuit, or implemented algorithmically within the microprocessor. However, there is an additional risk that once pulses of adjacent nodes collide once, they will continue to collide as a result of quartz crystal based timing of designs which, by their nature, ensure there is little drift between the timing of successive pulses; thus they can potentially continue to collide. Under these conditions, even filtering may not remove the false end of line detect signals as the coincident pulses may continue to occur for long durations before eventually drifting apart due to the asynchronous slow drifting nature of clocks in separate nodes. Thus it is beneficial to provide some randomisation to the repeat period of pulses within the design of nodes. This can be achieved by seeding a pulse repeat timer with a value based on the sum of a repeat time and a randomising time. The value associated with the randomising time could be based on a unique, random or pseudo random number such as a mac address, universal unique identifier (UUID) of the device, etc. If this method is employed, it is still possible that pulses from two adjacent nodes may coincide once, however the probability of a successive second, or third pulse collision is now statistically very low.

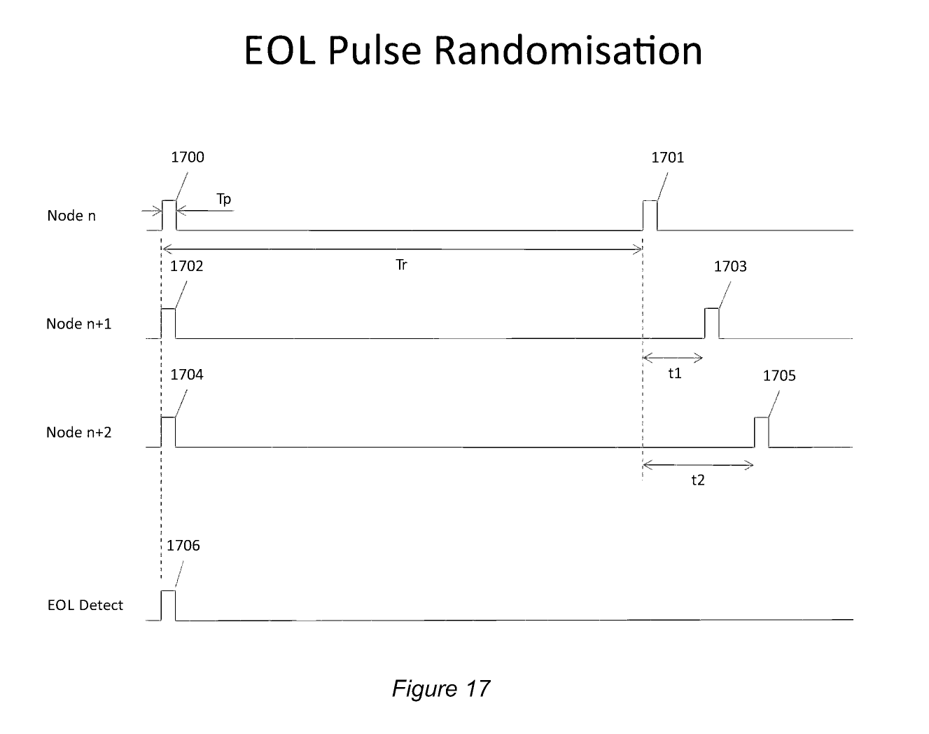

FIG. 17 illustrates this concept of EOL pulse randomisation. Devices generate EOL detection pulses 1700 of width Tp which are repeated with a base repeat time of Tr. These pulses are also represented by pulse 1108 shown in FIG. 11. The figures are not to scale, as by way of example, time Tp may be 30 microseconds wide and Tr may be 100 milliseconds. If no time randomisation of pulse repeat time is applied, all nodes would generate a second pulse 1701, 100 milliseconds after the first pulse 1700. Node n+1 utilises randomised time for pulse generation by adding a time t1 to the base repeat time Tr. Thus the second pulse 1703 is generated at a time determined by the sum of Tr+t1 after the first pulse 1702. Similarly Node n+2 utilises randomised time for pulse generation by adding a time t2 to the base repeat time Tr. Thus the second pulse 1705 is generated at a time determined by the sum of Tr+t2 after the first pulse 1704. While not shown, t2 may be shorter than t1. The figure further illustrates the situation where devices n+1 and n+2 generate coincident pulses 1702 and 1704, thus an EOL detect pulse 1706 is generated. However, the results of applying randomisation to pulse repeat times is that even though the first pulses 1702 and 1704 coincide, the second subsequent respective pulses of 1703 and 1705, do not coincide, thus no EOL Detect output is generated.

Additionally, if the microprocessor receives an end of line detect condition, whether filtering is employed or not, the microprocessor can then re initiate a completely separate sequence of test pulses, to test whether the detection signal can be trusted. These test pulses could utilise very different pulse repeat times to the standard range of pulse repeat times to effectively “double check” that the end of line signal does not change state, thus is trusted to be reliable before “officially” changing the status of the device to be set to end of line, which may be represented by setting a flag in memory or setting the state of an input/output line.

The microprocessor (micro) can then be used to change the function of the device as required depending on its position within the network. For example, it can be used to enable a terminator, drive a led indicator, signal a flag to an installer that this device is the last in the network, etc.

Thus reliable detection of a neighbour can be achieved with a symmetrical circuit, enabling the detection of one or two neighbours irrespective of whether adjacent devices are plugged into Con A, Con B, or both.

The circuits described in FIG. 11 provide the ability for devices to determine if they are at the end of the line of serially connected devices. Thus they are also used to signal if a device n is removed, as the previous device, n−1 signals that it is now the end of line. If device n has devices attached downstream to it, n+1, n+2, etc. it is advantageous to know that removing device n, also means that the subsequent devices, n+1, n+2, etc. are therefore also removed.

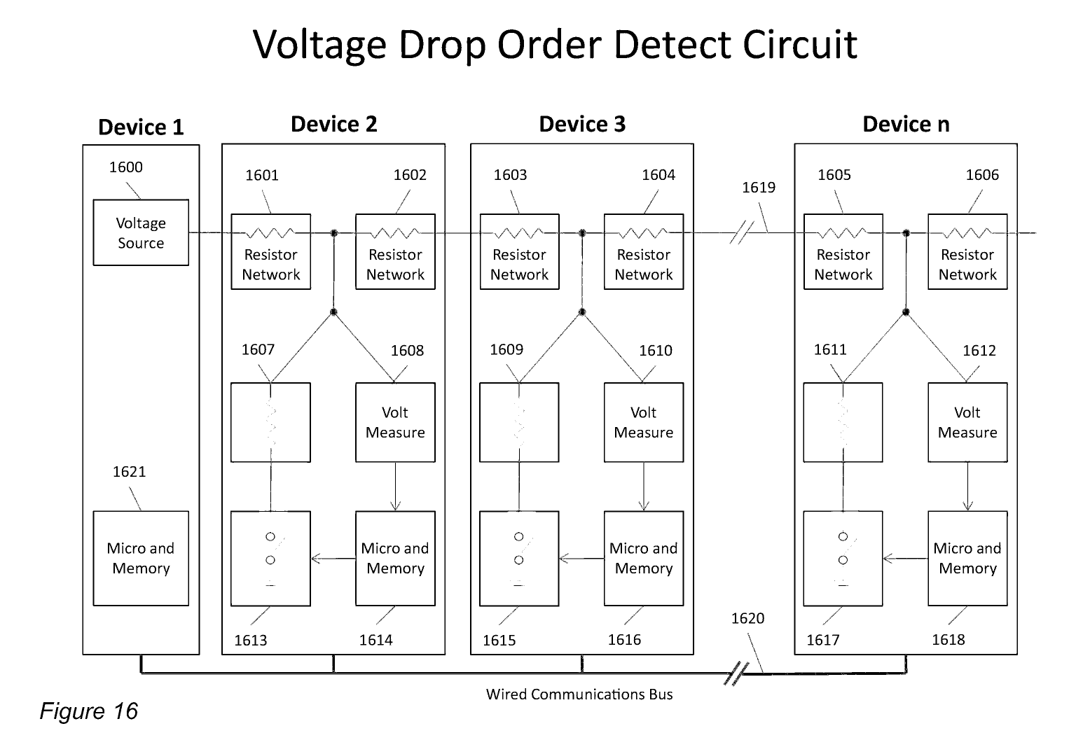

FIG. 16 represents the functional blocks used to implement a device order detect system. The principle of operation is that of a resistive ladder divider, where a voltage source is applied at the beginning of the ladder and when a load is applied to a point in the ladder, a current flows through the resistor network and a progression of decreasing voltage drops are measured along the ladder, the magnitudes of which are used to determine the order of the devices in the network. In this figure, Device 1 could represent a hub device and devices 2 . . . n could represent node devices. Although not explicitly illustrated, for simplicity purposes, it is assumed that each device has a wired communication transceiver that allows data to be communicated on wired communications bus 1620, allowing the devices to communicate with each other according to the data communications protocol utilised.

Device 1 contains a voltage source 1600. This is applied to a wire network 1619 interconnecting the devices and may be a continuous supply, or a momentarily applied voltage or voltage pulse. Device 2, 3 . . . n are equipped with resistor networks 1601-1606. These would typically be the same value of resistance, however, this is not necessary for the system to operate as they can be of different values. The wires of wire network 1619 have within themselves resistance which contributes to the total resistance between the nodes.

Device 2 has a resistive element 1601 which is switched to ground by switch 1613 under the control of microprocessor 1614. The switch may be a transistor or analogue switch and when ON current flows through the resistor network of 1601 and 1607. At about this time microprocessor 1614 receives a voltage measurement from volt measurement circuit 1608, Note this may be an analogue to digital converter and may in fact may be contained within the microprocessor 1614. The voltage is measured in this devices is at the intersection of resistors 1601 and 1607 with the voltage drop from the voltage source 1600 occurring across resistor 1601. The absolute voltage measured by circuits 1608 is the voltage of the voltage source 1600 minus the voltage drop across resistor 1601 (excluding interconnecting wire and terminal resistances). When long interconnecting wires are utilised between the devices, time delays will need to be added between the closing of the switch 1613 and measuring the voltage from 1608 circuits as to allow for inductive effects and resistive/capacitive rise times to ensure the voltage reading stabilises to provide accurate measurements. This voltage measurement is stored in the memory of the processor 1614 and is utilised later to determine its order in the network. When the voltage measurement is complete, the microprocessor 1614 turns switch 1613 OFF to release resistor 1607 from ground, stopping current flowing through the resistor network.

Device 3 has resistive elements 1603 and 1604. Similarly the microprocessor 1616 controls the switching of resistor 1609 to ground using switch 1615 and makes a voltage measurement using 1610 circuits. When the voltage measurement is complete, the switch is turned OFF to stop any current flow through the resistive network. At this node in Device 2, the voltage divider network consists of resistors 1601, 1602, 1603 and finally resistor 1609 to ground. Due to the additional resistance between the voltage source 1600 and the measurement point of voltage source 1610 in device 2, compared to the resistance between the voltage source 1600 and the measurement point of voltage source 1608 in device 1, there is recorded in the memory of the micro 1616, a lower voltage than was recorded in the memory of micro 1614.

Successively all devices make their voltage measurements and record their values in memory. The order and when the devices make the voltage measurement can be controlled by a hub device, which could be Device 1 in this example. However, the control of when the devices make the measurement is not important here; the point being that all nodes make a measurement, one at a time and record their voltage measurements. Then the microprocessor 1621 in device 1 can then request the voltage measurements from each node and knowing the address of the nodes, create a table in memory of the device addresses and their corresponding voltage measurements. This table can then be sorted from lowest voltage measurement to highest voltage measurement, which will then be reflective of the order of the nodes in the system with the lowest voltage measurement corresponding to the first node in the network, in this illustration this represents Device 2. The node with the highest corresponding voltage measurement will be the last node in the system, in this illustration this represents Device n. This last node can then be identified as requiring a terminator in networks that require their communications bus to be terminated, such as CAN bus.

Using this principle of determining node order, as the number of nodes on the network increases, so too does the accuracy of the voltage measurements need to increase. The limiting parameters determining the number of nodes to be accurately ordered will be determined by the tolerance of the shorting resistors 1607, 1609 and 1611 and the accuracy of the voltage measurements. In some cases resistors with accuracy of 0.1% may be needed. Where a small number of nodes are utilised, say 5-10, standard accuracy 1% resistors should provide suitable results. However, for a large number of nodes, say 50 to 100, very high accuracy resistors and voltage measurements will also be required. In the case of the voltage measurements, the accuracies and resolutions required may exceed the 4096 bits commonly available in microprocessor analogue to digital converters. In these cases, the method of determining node order as described below referencing to FIG. 11, will be more suitable, with no practical upper limit of the number of devices in the network.

With a small modification to the FIG. 11 circuits, it is also possible to determine the sequential numerical order of the devices, thus making it possible to know all the devices that are removed from the network when a change in end of line occurs.

This can simplify the processes required to determine which nodes are removed. Typically a DB Hub may poll devices to determine if they are present in the network. If it is not present, it is typical to have several retries and eventual timeout to arrive at the conclusion that a particular device is removed from the network.

Referring to FIG. 9, DB Hub 900 can communicate to the nodes in the network a command to enter a pulse order determination mode.

Referring to FIG. 11. By adding a tri state drive capability to Pulse Generator 1109 its clamp to ground is removed. In this state the DB Hub can initiate a sequence of actions that can be used to determine the order of the nodes in the network as explained below.

Referring to FIG. 9, the DB Hub 900 enables its pulse generator and a pulse is generated. Since the node directly connected to the DB Hub, Node 1 has its pulse generator tri stated, the pulse is not clamped and therefore node 1 can detect the presence of the DB Hub's pulse. Provided there is no path for the pulse to propagate to Node 2 and Node 3, then only Node 1 will detect the DB Hub's pulse. Node 1 can then send its address or identifier to the DB Hub when it receives this pulse. The DB Hub can then record this nodes address as the first node in the order. Then Node 1 can generate a pulse. Likewise only its adjacent devices will detect or “hear” this pulse, the DB Hub and Node 2 in this case. Since the DB Hub's order is already known, it can ignore this pulse with no action. Node 2 however will hear the pulse and be able to report its address to the DB Hub which then records this as the second device in the network. Repeating this process, Node 2 generates a pulse which Node 1 and 3 hear. Node 3 therefor reports its address and the DB Hub records its order. Continuing this method allows the DB Hub to build up a table of device addresses and the associated order in which they are connected within the network.

Hence in this example if Node 2 is removed, Node 1 will change state, indicating it is now the end of line. The DB Hub can then know that Node 2 and Node 3 have been removed.

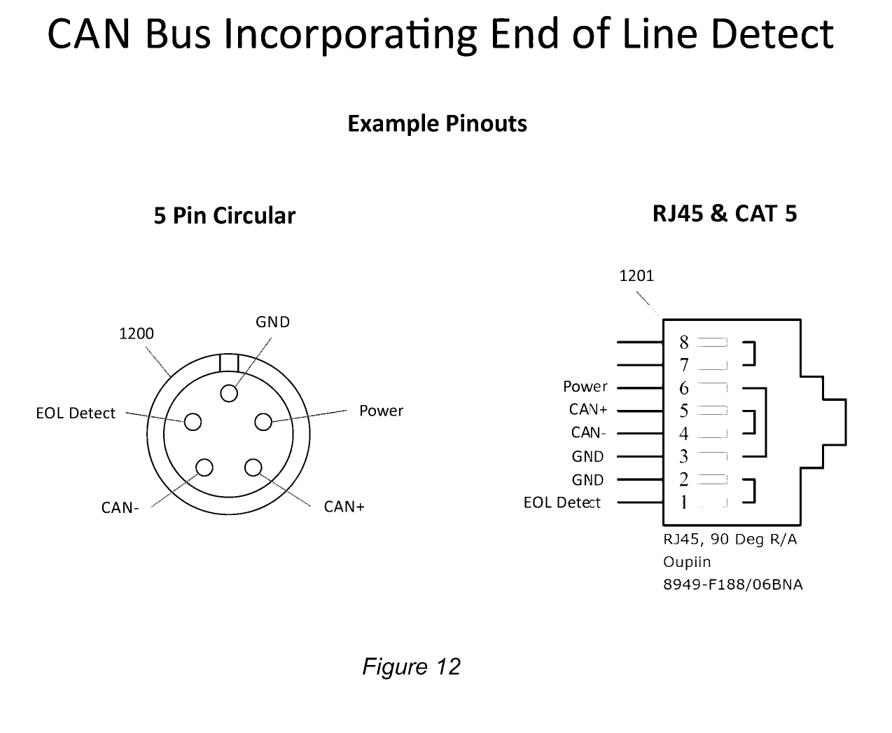

FIG. 12 illustrates two examples of physical connector systems that can be used to implement a CAN bus system incorporating the end of line detection functionality. In the example of the 5 pin circular connector 1200, only 5 pins are required, including power, ground, CAN+, CAN− and a single EOL Detect signal.

In the RJ45 connector example, commonly used in networking systems employing Cat 5 or Cat 6 cable, it is beneficial in that this type of cable employs twisted pairs, which are considered to be less subjected to noise in high noise environments and maximises propagation distances. In this case the signals have been strategically grouped to take advantage of the twisted pair benefits. CAN+ and CAN− signals are grouped onto a single twisted pair on pins 4 and 5. Power and ground are paired on pins 3 and 6 and the EOL Detect signal on pin 1 is paired with its own ground wire on pin 2. Other embodiments can naturally be employed without effecting the scope of this invention.

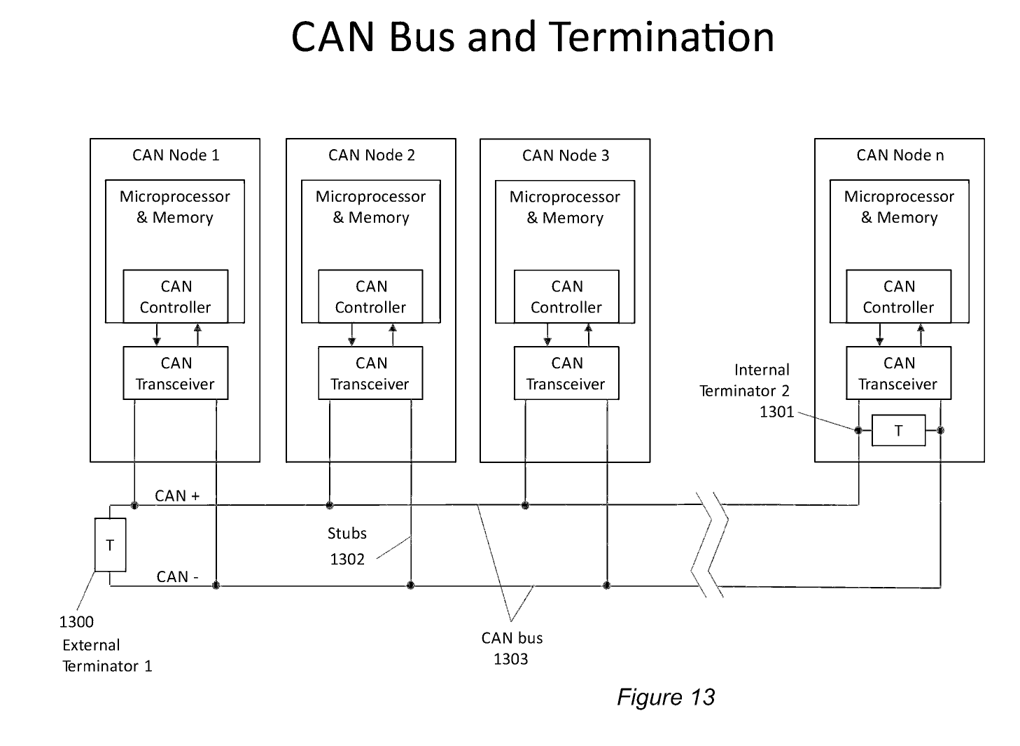

FIG. 13 illustrates how a CAN bus network utilises terminators. External Terminator 1 1300 is external to the nodes and is located at the beginning (or at one end) of the network wires, being positioned across lines CAN+ and CAN− on CAN bus 1303 as is a CAN bus requirement. CAN Node 1, 2 and 3 are not equipped with internal terminator circuits. However CAN Node n is equipped with Internal Terminator 2 1301, which is permanently located across the CAN+ and CAN− lines. This is located at the end of the network, thus conforming to the CAN bus requirements. Stubs 1302 are required to be kept as short as possible within the CAN network as they add discontinuities to the CAN bus and increase signal reflections. These sub lengths would typically be no longer that 30 cm, although usually they are only a few centimetres as the CAN connectors and transceivers are usually located on a printed circuit board.

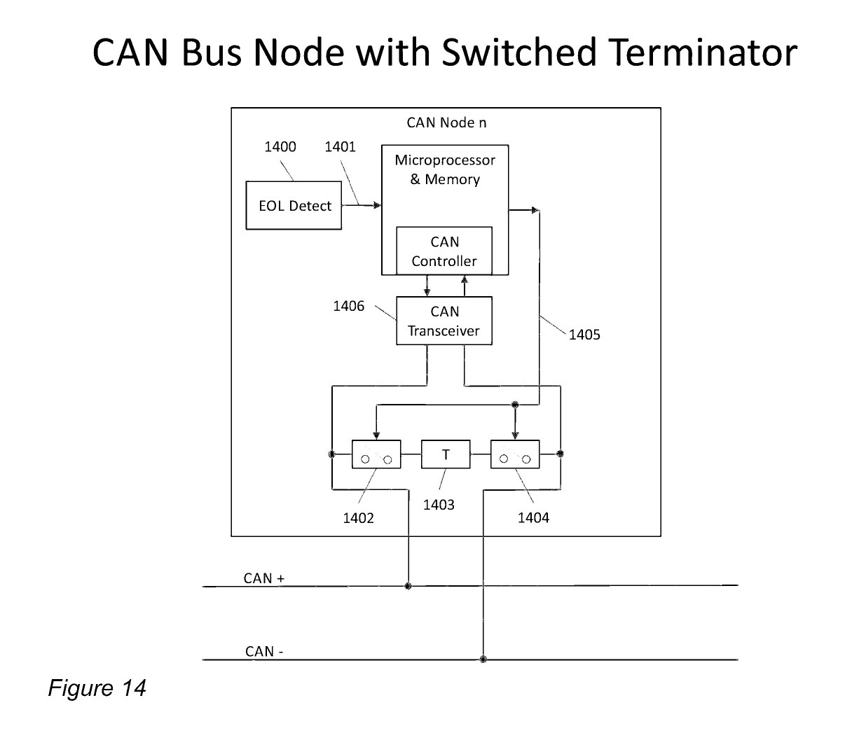

FIG. 14 illustrates a CAN bus node that has the ability to switch in or out the terminator 1403 using switches 1402 and 1404 such that when the switches are OFF, the terminator 1403 is no longer connected to the CAN+ and CAN− signals. Utilising end of line detect method described previously in this document, the EOL Detect circuit 1400 generates signal 1401 that informs the microprocessor 1406 whether the node (CAN Node n in this case) is at the end of the network line or not. If it determined to be at the end of the line, the microprocessor uses signal 1405 to switch ON switches 1402 and 1404, connecting the terminator 1403 to the CAN+ and CAN− signals, allowing the microprocessor send data on the CAN bus using the CAN Transceiver 1406. Thus a node can be configured to have its terminator switched ON or OFF, depending on its position within the network.

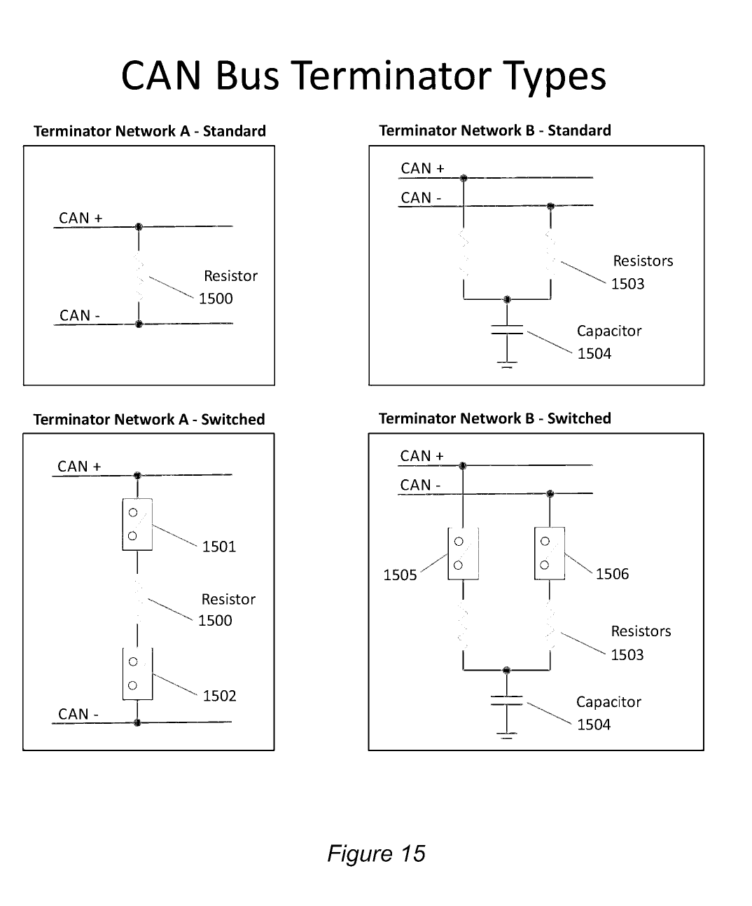

FIG. 15 illustrate two CAN bus terminator types, although others may exist. A standard single resistor terminator 1500 is often used across the CAN+ and CAN− lines as illustrated in the Terminator Network A—Standard illustration. This resistor is nominally 120 Ohms and is positioned such that there is one located at each end of the bus. It is recommended to be of a power rating that is sufficient to withstand a power supply short circuit directly across the resistor in the case of a fault condition.

The Terminator Network A—Switched illustration shows an arrangement where the standard resistor 1500 is removed from connecting to the CAN+ and CAN− signals using switches 1501 and 1502. These switches can be implemented with relays, transistors, analogue switches, or other switching devices. Consideration must be given to ensure that the switching circuit can withstand the maximum current flow through the circuit in the case where the power supply is shorted directly across the switches or resistor in the case of a fault condition. Additionally, if transistor switches are used, it is important that the biasing of these is designed in a way that ensures the transistor remains ON or OFF in the appropriate state under all CAN bus conditions, particularly if the CAN bus signals exhibit common mode voltage swings.

Terminator network B—Standard illustrates a split terminator style preferably used if filtering and stabilisation of the common mode voltage of the bus is desired. Split termination uses two 60 Ohm resistors 1503 with capacitor 1504 between these then connected to ground. Split termination improves the electromagnetic emissions behaviour of the network by eliminating fluctuations in the bus common mode voltages at the start and end of message transmissions.

Terminator Network B—Switched illustrates one configuration of isolating the resistors 1503 from the CAN bus signals CAN+ and CAN− using switches 1505 and 1506. Similar care is needed for the power rating of the terminator resistors and the switching networks and also to ensure that the switches remain ON or OFF as required under all common mode conditions of the bus.

Throughout this specification, the concept of powering down a data communications driver or transceiver has been discussed to save power. This can be achieved by either de asserting one or more chip selects of the transceiver which puts it into a low power state, or the chip itself can have one or more power supplies removed, thus completely turning OFF the transceiver circuit connected to the communications bus. If the supply is removed, it is possible that the bus data output driver or protection circuits will load the bus, preventing data communication on the bus even if another device in the network powers up its communications transceiver. Often output circuits have clamping diodes or networks that provide limiting and protection to over voltages on the data communications bus. Limiting is generally achieved by clamping data lines to the supply rails of the chip. Thus, if the supply of the chip is removed, the clamping diodes' reference/clamping voltage will collapse to ground and pull the data lines to ground also, hence loading the bus, preventing other devices from using it.

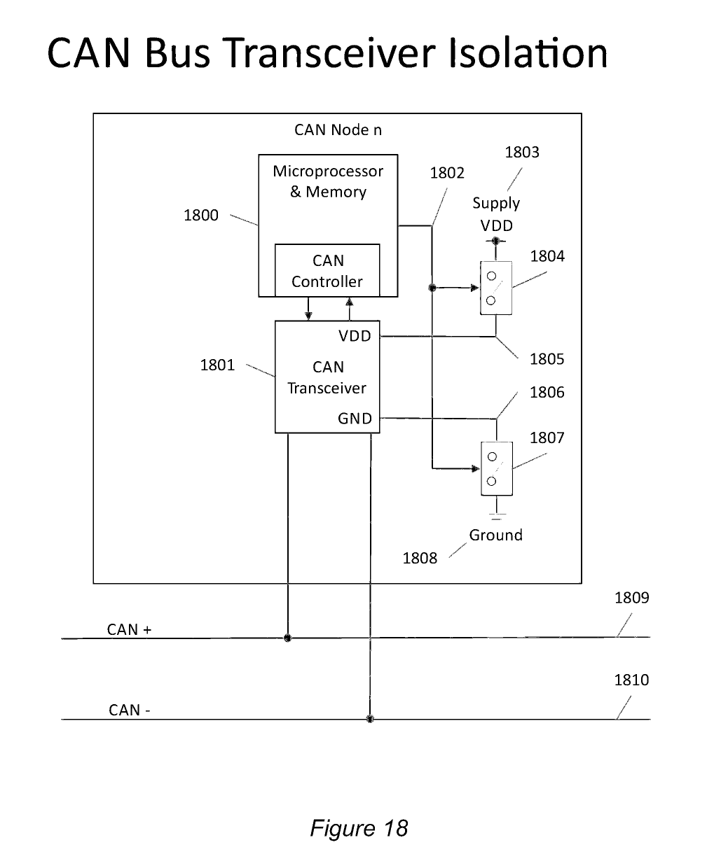

In this circumstance it may be necessary to isolate both the supply and the ground from the transceiver which generally eliminates the loading problem as the output circuit is now fully floating. FIG. 18 shows an example of how this principle of how isolating the supplies can be implemented. Normally microprocessor 1800 communicates with the data communications bus lines 1809 and 1810 using CAN Transceiver 1801 which is normally powered with a supply VDD and Ground. In this example the system Supply VDD 1803 is isolated from the CAN Transceiver chip 1801 with switch 1804, providing a switched supply 1805 to supply the chip 1801. Similarly Ground 1808 is isolated using switch 1807, providing a switched ground 1806 to the chip. Under normal data communication modes, switches 1804 and 1807 will be switched ON, providing a supply and ground to the CAN Transceiver chip 1801. When the Microprocessor 1800 initiates low power mode, it outputs the relevant state on control line 1802 to turn OFF switches 1804 and 1807 providing a high impedance/tri state condition to the transceivers VDD and GND pins. These switches could be relays or transistors.

Under these conditions where the transceiver chip is powered down, there is minimum bus loading and can allow for a larger number of transceivers to be connected to the data communications bus than might normally be possible. Although not illustrated, it is obvious to a person skilled in the art, that an alternative method of bus isolation would be to place the switches in the path of the transceiver data lines (in this case the CAN+ and CAN− lines) isolating the CAN Transceiver output from the data communications lines 1809 and 1810 on the main communications bus.

1. An arrangement for managing communication between two or more devices connected using a wire signal communication medium, the arrangement including;
a first device having a processor, memory, one or more communication mechanisms, the first device having access to one or more resource management files wherein one of those resource management files includes data representative of at least a portion of the resources for enabling communication with a second device; and
a second device having a processor, memory, one or more communication mechanisms, and the second device having no access to the one or more resource management files of the first device, where the first and second devices are connected such that at least one of the communication mechanisms, exchanges data between the devices to facilitate the communication of the resource management file of the first device to the memory of the second device using one or more of the communication mechanisms, and for processing the resource management file by the processor of the first device to allow data to be exchanged between the first and second devices.

2. A sensor and control network using a wire signal communication medium connectable, and in use, having two or more devices connected to the wire signal communication medium, to facilitate the communication of signals or pulses between devices in the network, comprising:
two or more devices, each device having:
a power supply circuit energized and operable when connected to a source of electrical power;
a central processing unit which has at least a minimum power consumption state when powered by the power supply and control of the communication protocol used by the device,
a digital memory from which is readable at least a resource management file of the device, a unique identification of the device, and none, one or more of:
a digital representation of the device type;
a digital representation of the resource management file of the device;
at least one associated protocol transceiver controllable by the central processing unit for communication of the protocol from the protocol transceiver to and from the wire signal communication medium,
wherein the associated protocol transceiver has an ON state and an OFF state and is in an OFF state when the central processing unit is in the minimum power consumption state,
a wakeup circuit for waking up the central processing unit from the minimum power consumption state to change the state of at least the associated protocol transceiver to ON, and
a circuit to generate a predetermined pulse or data characteristic adapted for waking up the central processing unit of another device, wherein the circuit generates the predetermined pulses or data characteristic when instructed by the central processing unit;
wherein the wire signal communication medium connectable, and in use, connected to each device of the two or more devices facilitates the communication of signals between devices using at least the protocol transceiver of a respective device including the communication of data to enable communication of a resource management file of at least one device to the other device.

3. The sensor and control network of claim 1 further comprises
a sensor associated with the device in communication with at least the central processing unit of the device.

4. The sensor and control network of claim 1 wherein the central processing unit of a device, once woken up, signals at least the communication driver of the same device to receive the unique identification of another device connected to the wire signal communication medium.

5. The sensor and control network of claim 1 wherein the receipt of a unique identification of another device by the communication driver provides a wake-up signal to the communication driver.

6. The sensor and control network of claim 1 wherein the each device is able to monitored and/or controllable as determined by the execution of a resource description file by a controller device which is connectable to the network of devices.

7. The sensor and control network of claim 1 wherein the wire signal communication medium carries one or more power sources to one or more connected devices.

8. A wake up circuit to wake up a device from a minimum power consumption state, the device having a central processing unit which has a minimum power state, and at least an associated protocol transceiver and communication driver connectable connected, in use, to a wire signal communication medium and for communication of the protocol to and from the wire signal communication medium, wherein the associated protocol transceiver and communication driver have an ON and OFF state and are in the OFF state when the central processing unit is in a minimum power consumption state, the circuit comprising:
a pulse detector having one or more signal inputs connectable and connected to the wire signal communication medium, and one output connectable and connected to the central processing unit of the device, and
a pulse detection circuit for receiving a predetermined pulse or data characteristic, wherein when a predetermined pulse or data characteristic is received by at least one of the inputs a signal is generated on the output to wake up the central processor of the device which turns on the communication driver to receive signals on the signal communication medium.

9. The wake up circuit of claim 8 further comprising:
a reset circuit for resetting the waking-up device to a state to receive a further pulse absent the effects of a prior pulse.

10. A pulse generator device controllable by a digital processor and the pulse generator device connectable and in use connected to a wire signal communication medium, the pulse generator comprising:
a pulse circuit for creating a voltage transition of either a positive or negative polarity about zero volts, or some predetermined level, at a predetermined rate when more than one pulse is generated and each voltage transition having a predetermined rise characteristic, and
an interface circuit for applying the voltage transitions of the pulse circuit to a wire signal communications medium, wherein the voltage pluses generated are adapted to be received by a pulse detector as defined.

11. A detection circuit for enabling the detection of the position of a device within a wired network comprising: at least one device providing one or more voltage or current pulses to the wired network and devices connected to the wired network have a circuit to detect the voltage or current pulses, wherein the circuit measures a parameters of the wired network such as voltage or current and using the measurement, either directly by the device or by communicating these measurements to other devices within the network; the position of a device is determined, by determining the power consumed during the pulse generation/measurement and having a measurement of the inherent resistance in the wires of the network and associated connectors, the progressively larger voltage drop along the wire as wire length increases determines the relative position of the device along the wired network, wherein the magnitude of the voltage drops is associated with each device identification and the order of the devices is determined.

12. A circuit in accordance with claim 11 wherein these wired network is compatible with the use one of the group: CAN bus, Serial UART, RS485, SMBus, I²C, BACnet, ModBus, LIN (local interconnect network).

13. A detection circuit for enabling a detection of a position of a device having an identifier within a wired network, comprising: a source for providing one or more voltage or current pulses to the wired network and devices connected to the wired network; a circuit within the device to detect the voltage or current pulses, wherein the detected voltage or current pulses and the device identifier is used to determine the position of the device within the wired network.

14. A circuit in accordance with claim 13 wherein the wired network is compatible with the use of one of the group: CAN bus, Serial UART, RS485, SMBus, I²C, BACnet, ModBus, LIN (local interconnect network).

15. The wake up circuit of claim 8 wherein the wire signal communication medium is compatible with the use one of the group: CAN bus, Serial UART, RS485, SMBus, I²C, BACnet, ModBus, LIN (local interconnect network).

16. A wake up circuit to wake up a device from a minimum power consumption state, the device having a central processing unit which has a minimum power state, and at least an associated protocol transceiver, and a communication driver connectable connected to a wire signal communication medium for communication of a protocol to and from the wire signal communication medium, wherein the associated protocol transceiver and communication driver connectable have an ON and OFF state and are in the OFF state when the central processing unit is in a minimum power consumption state, the circuit comprising:
an out of band wireless communications mechanism having an ability to receive one or more predetermined signal inputs and at least one output state accessible to the central processing unit of the device, wherein
a predetermined signal input received by the out of band communication mechanism wakes up the central processor of the device to turn on the communication driver connectable to receive signals through the wire signal communication medium.

17. The wake up circuit of claim 16, wherein the out of band wireless communications mechanism utilises a BLE (Bluetooth Low Energy) protocol.

18. A sensor and control network of claim 2, further providing isolation circuits that provide isolation of the protocol transceiver to the wire signal communication medium wherein the central processing unit controls the isolation circuits, to effect the minimum power consumption state of a device.
